(19) United States
(12) Patent Application Publication
(10) Pub. No.: US 2025/0179665 A1
(43) Pub. Date: Jun. 5, 2025

(54) ELECTROCHEMICAL STACK

(71) Applicant: Baumgartner & Lamperstorfer Instruments GmbH, Feldkirchen (DE)

(72) Inventor: Michael LANGE, Feldkirchen (DE)

(73) Assignee: Baumgartner & Lamperstorfer Instruments GmbH, Feldkirchen (DE)

(21) Appl. No.: 19/100,662

(22) PCT Filed: Jun. 29, 2023
(86) PCT No.: PCT/EP2023/067790

§ 371 Date: Feb. 3, 2025

(30) Foreign Application Priority Data
Jun. 29, 2022 (DE) 102022116183.8

(51) Int. Cl. C25B 9/63; C25B 9/01; C25B 9/23; C25B 9/65; C25B 9/77; C25B 15/08

(52) U.S. Cl. CPC C25B 9/63; C25B 9/01; C25B 9/23; C25B 9/65; C25B 9/77; C25B 15/08

(57) ABSTRACT

An electrochemical stack comprises a plurality of planar electrochemical cells having surfaces bounded by outlines and disposed surface to surface adjacent one another with bipolar plates disposed there-between, and mounted in openings having corresponding outlines in insulating holders, the holders being clamped together between end plates and there being seals between each end plate and the adjacent holder and between confronting regions of adjacent holders. In the claimed design a plurality of stack modules are provided in the holders and between the end plates. The stack modules preferably have the same orientation in space. (FIG. 5A)

The present invention relates to an electrochemical stack comprising a plurality of planar electrochemical cells having surfaces bounded by outlines and disposed surface to surface adjacent one another with bipolar plates disposed there-between, the cells being mounted in respective openings having corresponding outlines in the insulating holders, the holders being clamped together between end plates or end electrodes and there being seals between each end electrode or plate and the adjacent holder and between confronting regions of adjacent holders. The seals between confronting regions of adjacent holders do not necessarily seal against the adjacent holder but can, in a variant, can also seal against opposite sides of bipolar plates disposed between adjacent, i.e. confronting, holders.

An electrochemical stack of this kind is known from German patent application DE 10 2021 117 722.7 of the present applicants. In such an arrangement each cell has an anode side and a cathode side in which porous electrodes are present with gas impermeable but charge transmitting membranes between them. Such membranes are either anionic membranes such as Fumasep of Fumatech in Germany, A201 of Tokuya, a in Japan, or AEMION of Ionomr in Canada, or proton exchange membranes (PEM) such as Nafion. Such Ion exchange membranes transmit ions such as OH+ anions and H− ions. Thus OH+ ions migrate to the cathodes and recombine there to form H₂ and water. The porous spaces at the anode and cathode sides are referred to here as the anode and cathode spaces.

An electrochemical stack of this kind can, for example, be an electrolyser such as the electrolyser disclosed in German patent application DE 10 2021 117 722.7 of the present applicants, or could also be a fuel cell stack or a reformer. In a practical embodiment of the electrolyser disclosed in DE 10 2021 117 722.7, the holders are circular and can have an external diameter of about 300 mm and the electrochemical cells are generally square and can have a length and width of about 200 mm. This signifies that the ratio of the area of the active area of each cell to that of a holder is about

$$( 200 \times 200 ) / ( π \times {( 300 / 2 )}^{2} ) = 0.57$$

Bearing in mind that space is necessary within the holders for seals, clamping bolts, inflow and outflow passages and manifolds as well as seats for the cell components and to achieve adequate stability of the holders against the mechanical loads that arise, a value of about 0.57 is about the maximum that can be achieved for a square cell arrangement within a circular plastic holder. A particularly significant advantage of this design is that the circular holders, and optionally the end plates or end electrodes, can be provided with circular ring grooves at their peripheral regions which enable them to be pressed together by, e.g., bolts arranged in their peripheral regions, and sealed by O-rings disposed in the circular ring grooves. For example, when an anodic electrolyser is used and water containing an ionic salt such as KOH is supplied under pressure to the anode side or anode space of each cell, a considerable pressure exists in the anode space of each cell and the electrolyte (such as distilled water and KOH) flowing through it together with the oxygen generated at the anode side by electrolysis is expelled under pressure from the anode space into a collector for the electrolyte and a separator for the generated oxygen. Moreover, hydrogen, in a moist state and under a significant pressure, flows through the cathode spaces at the cathode sides of the cells to the hydrogen outlet.

The flow through the cells is generally parallel to the planes of the cells but also necessarily into the fine porous structures adjacent the membranes where the oxygen and hydrogen generated by electrolysis are separated. Since the flow of water with conductive ions through the cells is generally parallel to the planes of the cells these can be made relatively thin, e.g. about 3 mm thick at each of the anode spaces and cathode spaces. Thus, each cell and therefore each holder is basically flat and can have a total thickness of 6 mm, hence the description planar. Such relatively thin planar cells can be accommodated in a relatively small space leading to a high output per unit volume.

The above-described example, with a ratio of 0.57, is given for the preferred electrode design of the application DE 10 2021 117 722.7. For other electrode designs different values can readily apply. Similar circumstances apply to electrolysers using PEM membranes and to fuel cells where, for example, hydrogen, or a hydrogen-rich synthesized gas and air are catalytically combined to generate water and electricity. They also apply to reformers used to split fuels into hydrogen rich synthetic gases and water.

The desire to covert surplus electrical energy generated by photovoltaic panels or wind generators into hydrogen and oxygen or other fuel gases leads to a desire for ever larger generating capacities from tens of kilowatts to megawatts. To cope with such large capacities, designers are currently working on ever larger electrolysers. However, the designs currently under investigation lead to higher operating pressures, heavier constructions, inefficient use of materials and complex and costly electrical circuits.

It has been found that with a highly efficient electrolyser the amounts of oxygen and hydrogen that are generated is such that at the outlet side of the anode spaces of the cells there is so much oxygen present that ever higher pumping pressures are necessary to ensure liquid electrolyte is present throughout the anode spaces. Increasing the volume of the anode spaces to reduce the pumping pressure is counterproductive since more volume and more expensive material are required in the individual cells and in the end plates to withstand the mechanical stress without leaking.

Moreover, if gas is present in large quantities, there are areas of the cells in which no electrolyte is present and these areas do not contribute at all to the generation of hydrogen or oxygen. Thus, some of the surface area of the membranes is effectively unused and the cell does not have uniform fuel, i.e. hydrogen, generating capacities over its full area. Similar problems can occur in fuel cells and reformers.

The object of the present invention is to provide a design of an electrochemical stack, particularly for an electrolyser, but also applicable to other systems such as fuel cells or reformers, which is significantly more efficient, which does not require huge operating pressures, which leads to an efficient use of materials and greatly simplifies the electrical circuits that are needed.

In order to satisfy these objects, there is provided an electrochemical stack of the initially named kind which is characterized in that a plurality of stack modules is provided in the holders and between the end plates, and in that the stack modules preferably have the same orientation in space, each cell having an anode and a cathode with a charge exchange membrane, being one of an anion exchange membrane (AEM) and a proton exchange membrane (PEM), disposed between them, with the anode and the cathode contacting respective sides of the charge exchange membrane.

By providing a plurality of stack modules in an electrochemical stack the size of each module has to be reduced in order to physically accommodate the stack modules and the associated elements such as inflow and outflow passages, inlet and outlet manifolds, seats for electrodes and clamping bolts in the space available. Indeed, the total area of the cells of the stack modules is frequently such that the above-mentioned maximum ratio of 0.57 has to be reduced somewhat. Nevertheless, because the cells operate more efficiently with less wasted area and reduced operating pressures, there is a net gain in the efficiency and cost effectiveness of the electrochemical stack.

Moreover, since the stack modules can be operated from a single pressure source feeding water with conductive ions to the anode spaces of the cells via passages in the holders and optionally in the end electrodes or plates and in the bipolar plates. In this way the complexity at the feed side of the electrochemical stack can be greatly simplified.

The smaller size of the stack modules also lessens the danger of cracking due to differential thermal expansion during reduction and sintering of the electrodes.

In addition, by providing the stack modules in the holders with the same orientation, gravity can be exploited to aid the separation of the oxygen from the electrolyte in the anode spaces of all the stack modules.

When using just two stack modules, it is difficult, but not impossible, to make effective use of the whole area of the holders. However, with three, four, five or six stack modules the full area of the holders can be efficiently filled with stack modules so that ratios approaching or even slightly exceeding 0.57 can be easily achieved. Moreover, it is possible to provide a clamping bot extending through the middle of the electrochemical stack so that excellent clamping can be achieved by the central bolt and a number of peripherally arranged clamping bolts.

If seven stack modules are provided, these can be arranged with one stack module at the centre of the electrochemical stack and six stack modules arranged in a ring around it. Clamping bolts can then be arranged at intervals around the central stack module and at further intervals around the ring of six stack modules surrounding the central stack module.

Seven stack modules is the preferred design and it has proved possible to provide openings with a square shape of 80 mm×80 mm in the holders for the seven stack modules and indeed within holders of 300 mm diameter. More than seven stack modules could be considered but the design then tends to be very complex without achieving any significant gains in efficiency. The use of nineteen stack modules seems to be the maximum that can be reasonably accommodated in a single stack with circular holders.

In addition, since the full areas of the cells are available for electrolysis, the net resistance of the stack modules is reduced and the electrical energy supplied to carry out the electrolysis is more efficiently used. In addition, since the electrodes of each stack module are smaller than with one stack module in the sane holder, the danger of stress cracking of the cell components due to differential shrinkage during reduction and sintering is reduced.

For the sake of completeness reference should be made briefly to several prior art arrangements. In a search report on the priority application the following references were named:
D1 DE 20 2016 101 811
D2 WO 2016/110344,
D3 JP2002-367 637 (with partial machine translation) and
D4 U.S. Pat. No. 6,383,347.

It was suggested that all of the references D1 to D4 are relevant to claim 1 and that D4, i.e. U.S. Pat. No. 6,383,347, is relevant to the majority of the claims including the two essentially independent claims. Of these the first independent claim basically claims a plurality of stack modules each having a plurality of electrolysis cells in one stack and the second independent claim covers the concept of the DC power supply having a first pole connected to both end plates of a stack module and a second pole connected to a central plate of the stack module.

Dealing with each of the references in turn we have the following comments:
DE 20 2016 101 811, is concerned with a fuel cell stack, not an electrolyser, and only shows a single fuel cell stack, but not a stack with a plurality of stack modules. The main point of the reference is the use of piezoelectric elements to clamp the cells together.
WO 2016/110344 also discloses a single fuel cell stack and not a stack with a plurality of stack modules. It is concerned with the direction of flow through the stack and there is no mention of a plurality of stack modules within one stack.
JP2002-367 637, relates to a solid electrolyte polymer fuel cell and the specific embodiment discloses a fuel cell having two stacks each with a plurality of cells. However, the design is completely different from the present invention, the two stacks are not designed as stack modules arranged with the stack modules or the cells thereof in common holders.
U.S. Pat. No. 6,383,347 does relate to an electrolyser and basically discloses two different embodiments. In the first embodiment four cell blocks are provided which are connected in series and each cell block comprises two cells connected in parallel. It is made clear that the two cells could be increased to a larger number of cells. In the second embodiment, only a single stack is shown, but not a stack with a plurality of stack modules.

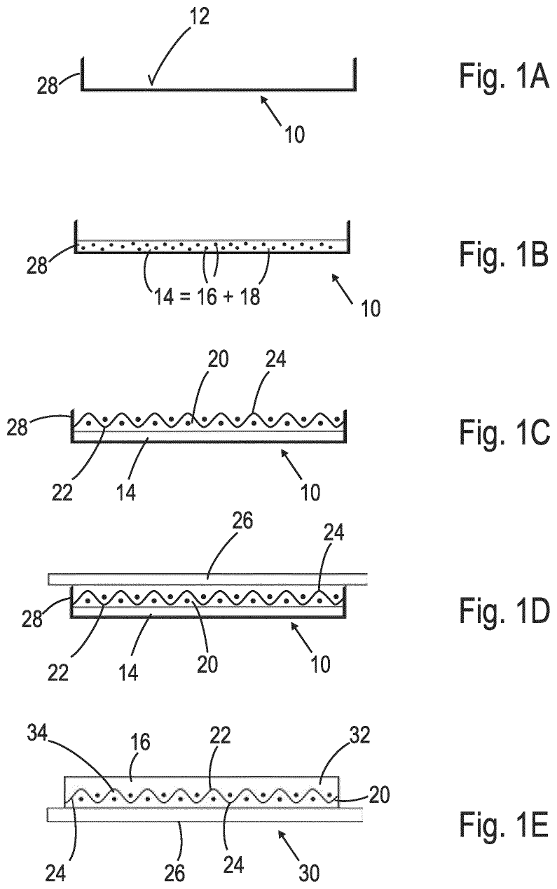

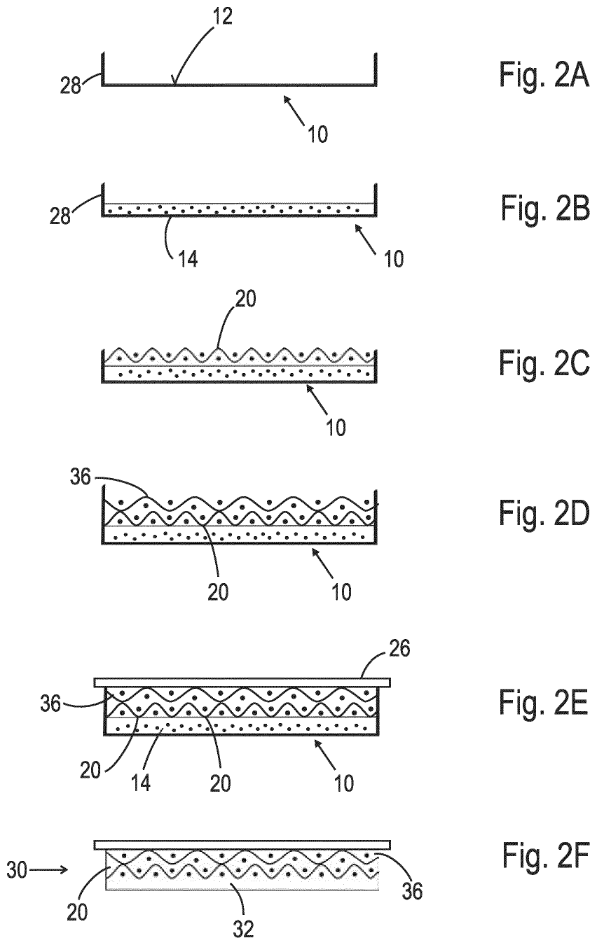

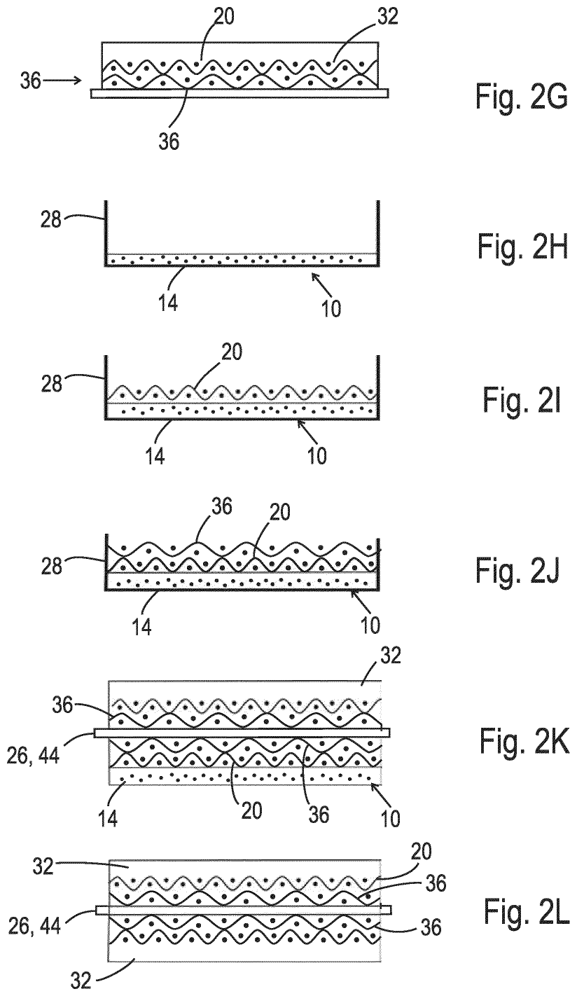

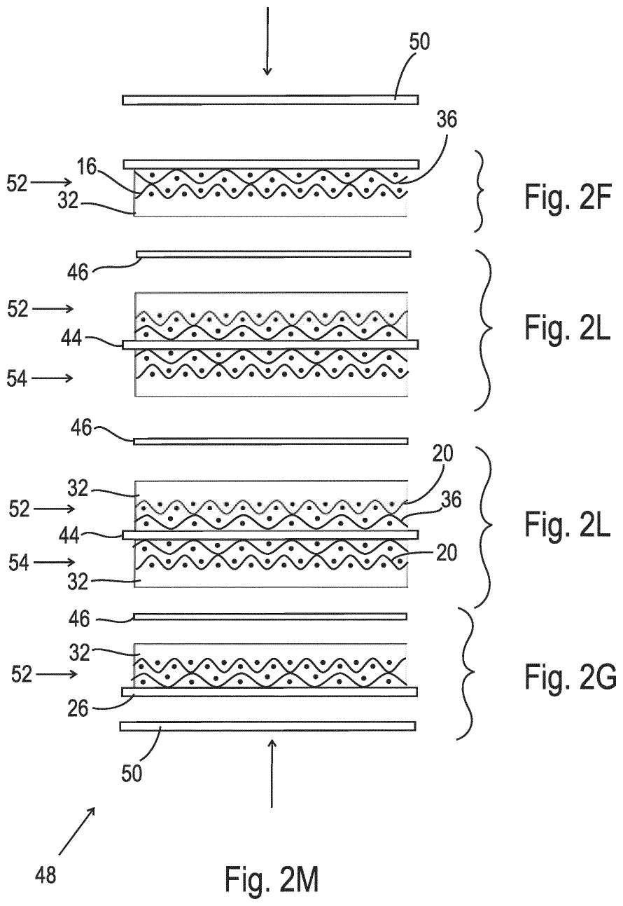

First of all it is important to note that the reference U.S. Pat. No. 6,383,357 clearly describes the arrangements shown there as a mono-polar cell design and clearly distinguishes this design from a bipolar design to which the present invention relates. According to U.S. Pat. No. 6,383,357 a conventional bipolar design is one in which current flow through the stack is perpendicular to the plane of the electrode (the plane of the electrode defined by the gas evolving surfaces of the electrodes) and importantly that the current flow is contained within the cell stack. This also means that the internal electric field in bipolar design extends perpendicular to the planes of the bipolar electrodes. In contrast, in the design of U.S. Pat. No. 6,383,357, the current flow in the electrodes is parallel to the working face of the electrode plates. This is also shown in the FIGS. 1 and 2 of the multiple stack electrochemical system MSE, in which the positive terminal of the power supply is connected to the anodes at one side of the four modules and the negative terminal of the power supply is connected to the cathodes at the other side of the four modules. This also means that the electric field in the design of the reference extends from right to left in the plane of the electrodes and not perpendicular to them.

The reference likens the design used there to a stack in which the monopolar cells are assembled as a contiguous stack of cells (cell stack) appearing similar to a filter press where the electrical connections between adjacent stacks are made using the double electrode plates. Since the cell blocks are necessarily connected in series due to the use of the double electrode plates, there is no possibility of connecting them in parallel or of connecting some cell blocks in parallel and some in series which makes it impossible to flexibly adapt one design to different and optionally varying power supplies.

The design of U.S. Pat. No. 6,383,347 in fact relates to different type of electrolyser from the present invention, namely an to a basic form of electrolyser that has an electrolyte at both an anode space and a cathode space in each cell. In the electrolyser of U.S. Pat. No. 6,383,347 the anode and cathode spaces are separated from each other by a separator which is not an ion exchange membrane exchange membrane but simply a separator intended to prevent hydrogen generated at the cathode and oxygen generated at the anode from mixing. Thus, in this basic form of an electrolyser, the separator is a barrier to gas.

In both of the two basic embodiments so called double electrode plates are used which extend from one cell to another. Such double electrode plates are not used in the multi module stacks of the present invention.

In addition, the four cell blocks of the reference are not integrated into common holders, as are the stack modules of the present invention.

Finally, it should be noted that none of the references discloses the concept of the present invention of using a DC power supply having a first pole connected to both end plates of a stack module and a second pole connected to a central plate of the stack module, which results in a higher internal electric field and a reduced external electric field with a corresponding improvement in efficiency.

In a preferred electrochemical stack in accordance with the present teaching the holders and preferably also the end plates are of circular shape, of elliptical shape, of polygonal shape or have a shape formed by curves and straight lines, such as a rectangular shape with two oppositely disposed sides being of rounded shape, preferably semi-circular shape.

This permits the use of O-rings for sealing without the O-rings having to undergo sharp changes of direction which would impair their sealing properties.

In a preferred electrochemical stack in accordance with the present invention, seals are provided between a peripheral margin of each end plate and the peripheral margin of an adjacent holder and between confronting peripheral margins of the holders. This prevents the leakage of electrolyte and gases from the electrochemical stack.

The seals provided between the end plates and the adjacent holders and between the confronting holders are located in respective grooves of circular shape, or of elliptical shape, or of a shape formed by curves and straight lines which ensures good sealing without losses of gas or liquid due to poor sealing at sharp changes of direction of the O-rings.

In a particularly preferred embodiment of the invention the planar cells of each stack module have generally rectangular, square, polygonal, triangular, trapezoidal, sector-shaped, circular or rhomboid shaped outlines. These are shapes into which the relatively expensive electrically conductive mesh material, which is manufactured in sheets, can be cut with no waste, or with only minimal waste, while still permitting efficient operation of the stack modules and extraction of the gases generated.

In a particularly preferred embodiment of the electrochemical stack of the present invention each stack module is surrounded by a plurality of respectively associated seals, the respectively associated seals being disposed between the end plates and the adjacent holders and between the confronting holders and being located in respective grooves of circular shape, or of elliptical shape, or of a shape formed by curves and straight lines surrounding the cells of each of the stack modules. As explained above the seals provided between confronting holders, i.e. confronting regions of adjacent holders do not seal against the adjacent holders but against bipolar plates provided between the adjacent holders.

In one preferred design the stack modules are fed with electrolyte, such as distilled water and KOH, from a common pump and the outlets of the anode spaces of the stack modules are connected to a common collector where the oxygen is separated from the electrolyte and the electrolyte is returned to the common pump.

This simplifies the layout of the electrochemical stack.

In a particularly preferred design of the electrochemical stack of the present invention each stack module has its own associated power supply terminals and a circuit is provided for flexibly connecting a desired number of stack modules in series and or in parallel to an associated power supply. An algorithm is preferably provided to flexibly connect the stack modules such that, over a longer period of time, each stack module is in operation for about the same length of time.

This design recognises that, when used with power supplies providing differing levels of power, such as a photovoltaic power supply with lower power output in the morning and evening and higher power output at midday, or seasonally varying power output, or tidally varying power from a wave generator, it is beneficial to apply the available power to a selected number of stack modules such that the selected stack modules are each operating at or close to maximum efficiency.

However, it can also be advantageous for each stack module to have its own associated power supply terminals and for a circuit to be provided for connecting a desired number of stack modules in series and/or in parallel to an associated power supply.

A circuit of this kind can easily be constructed using semiconductor power switches such as thyristors or FETs. This is particularly advantageous when the electrochemical stack is powered by a photovoltaic panel assembly. The current output of such a photovoltaic panel assembly is not constant but varies according to the time of day, the position of the sun and the degree of cloud. The voltage output is however substantially constant. With a photovoltaic power supply the output of the photovoltaic panel assembly can be connected directly to the electrolyser without needing any special electronics to modify the power supplied. When using the cell design of DE 10 2021 117 722.7 it has been found that the ideal cell operating voltage for maximum efficiency is around 1.8v to 2v. Thus, if the power provided by the power supply fluctuates it is advantageous to select the number of stack modules actually in use, for example by connecting more or fewer of them in series and/or in parallel, so that each cell operating is operating at an ideal voltage for maximum cell efficiency.

Thus, a relatively simple algorithm can be used to control the electrical circuit, i.e. the thyristors or other semiconductor elements, so that the ideal number of stack modules is in operation at any one time. This is an efficient way to operate an electrolyser from a photovoltaic panel assembly without needing complicated electronics to regulate the output of the photovoltaic power assembly to a constant value. Moreover, the algorithm can be designed so that over a longer period of time each stack module is in operation for about the same length of time. This can maximise the working life of the electrochemical stack and avoid untimely replacement or repair because one module has exceeded its working life.

In practice this means that each cell should operate with a potential difference of about 1.8 to 2 volts and at a current such that the maximum level of gas generation is achieved. By ensuring that each stack module operates for the same amount of time, on a long term average over one or more years, a situation can be prevented in which some stack modules of the electrochemical stack are over-utilised and therefore deteriorate prematurely, while others are underutilised.

It is particularly preferred for each stack module to have from 11 to 123 bipolar plates and especially from 11 to 61 bipolar plates, corresponding to from 12 to 108 and from 12 to 62 cells in each stack module. The reason for this can be best illustrated via some examples.

Let us consider the preferred arrangement of the invention. It is one in which an even number of cells is present in each stack module there being bipolar plates between the adjacent cells and electrodes at the endplates of the stack modules, which may be formed by the end plates, and one in which the central bipolar plate of each stack module is connectable to one pole of a power supply and the electrodes at the end plates are both connectable to another pole of the power supply.

If twelve cells are present in such an arrangement then that means there are six cells present on each side of the central bipolar plate. If the photovoltaic power supply delivers 12 volts minimum then that amounts to 2 volts per cell and the appropriate number of stack modules required to cope with the power delivered can be selected and connected in parallel.

If the photovoltaic power supply delivers 24 volts, then pairs of stack modules can be connected in series and the requisite number of pairs selected to maximise gas generation from the power available.

The above example is only realistic for a small photovoltaic installation. For a larger installation it would be more efficient to connect the solar cells together in such a way that the maximum output voltage is about 200 volts DC. This could then be used to power pairs of stack modules connected in series and each having 100 cells, i.e. 50 cells on each side of the central bipolar plate. In fact, it would be better to reduce the number of cells to 50 per stack module, i.e. 25 on each side of each central bipolar plate. Four stack modules would then need to be connected in series to achieve the desired voltage drop of 2 volts per cell. If the output from the solar cells is less than the 200 volt DC maximum then this can be applied to fewer stack modules connected in series, e.g. for 150 volts DC output, three stack modules of 50 cells each would need to be connected in series to achieve the desired voltage drop of 2 volts per cell.

If the electrochemical stack is to be operated using rectified mains AC power supplied at 220 volts, a simple full wave rectifier can be used, which—without smoothing—is equivalent to about 200 volts DC. Again four stack modules connected in series and each having 50 cells (25 on each side of the central bipolar plate) would be required to obtain a voltage drop of 2 volts per cell. Four stack modules connected in series would then operate at 2 volts per cell. If the potential available is 180 volts instead of 200 volts then this would equate to 1.8 volts per cell. Since a voltage, in the range from 1.8 to 2.0 volts, is ideal for efficient gas generation the stack can still be operated efficiently.

If a wind generator is used which produces three phase power at 400 volts equivalent DC output (rms voltage) then this could be shared between two stacks connected in parallel, each having four stack modules with 50 cells each (i.e. 25 cells on each side of the central bipolar plate) connected in series, since 400/2=200 volts is well within the range of 1.8 to 2 volts per cell needed for efficient gas generation.

If the output current of the wind generator, or other three phase generator, is too high for just two stacks connected in parallel—which is likely for wind generators—then a larger number of pairs of stacks each having four stack modules with 50 cells each (i.e. 25 cells on each side of the central bipolar plate) connected in series can be provided.

Also, it is not necessary to provide pairs of stacks to achieve such power sharing. For example, if a stack is provided with eight stack modules, then two groups of four modules connected in series can be connected in parallel. Also a plurality of stacks of this kind can be connected in parallel.

One advantage of the present teaching is that the resistances of the stack modules can be readily made substantially the same so that many pairs of stacks can be connected in parallel without having to provide special circuits to ensure equal power sharing between the stacks.

It is important to note that in all the above examples no special inductors, transformers or capacitors are required. The voltage from the power source can be supplied without any special form of regulation or filtering directly to the electrochemical stack. For an AC or three phase voltage only full wave rectification is necessary without smoothing or filtering. The DC ripple has no serious disadvantages in practice. Thus, an electrochemical stack, in the form of an electrolyser in accordance with the present invention, can operate efficiently with a variety of power supplies such as a DC output voltage of a solar panel assembly, or a rectified preferably unsmoothed voltage from an altemating current generator, from an AC mains supply, or from a three-phase generator.

Thus, an electrochemical stack in accordance with the present teaching in the form of an electrolyser can have an associated DC power supply, optionally in the form of a full wave rectified power supply. If the electrochemical stack is a fuel cell, then it forms a DC power supply.

A particularly advantageous embodiment of the electrochemical stack in accordance with the invention is achieved if the stack is arranged with the cells in a vertical plane or sloping upwardly so that the inlets to each anode space for electrolyte are arranged downwardly in the stack and the oxygen and electrolyte outlets of each anode space are arranged upwardly in the stack.

This embodiment recognises that in this orientation in space, which is the same for all stack modules of the stack, gravitational forced significantly assist the separation of oxygen from the water with ionic salt present at the anode side of each cell.

As indicated above it is possible, in one variant of the invention, for the electrochemical stack to have an associated power supply in the form of a DC-power supply. In the case of an electrolyser the DC-power supply can be one of an output voltage of a photovoltaic panel assembly or a rectified preferably unsmoothed voltage from an alternating current generator or from a three-phase generator.

It is also possible for the electrochemical stack to form a DC-power supply, for example when the electrochemical stack takes the form of a fuel cell, such as a direct methanol fuel cell.

The above examples show how designs in accordance with the present teaching can readily be matched to different power source voltages by varying the number of cells in each stack module and by selecting the number of stack modules in a stack. However, there is one design that is particularly flexible and which can be tailored to most of the power supply voltages which commonly occur in the world.

It is helpful to consider the typical operating parameters of different power sources in more detail. Typical photovoltaic power sources have outlet voltages of 12v, 24v, 48v 60v and 80v. Taking a photovoltaic power source of 60v output then this varies a few Volts depending on load and PV-module temperature. The maximum voltage which results is the no load voltage. Under load the voltage drops. When little light is incident, the voltage drops significantly more under the same load than with maximum incident sunshine. Moreover, the voltage is dependent on the module temperature. It drops with the solar module temperature from about 60.5V to 59.5V. The time of day and the time of the year in which the photovoltaic source is in operation are only secondary effects.

If an AC main supply is used as the power source, then it typically has a voltage of 120v at 60 Hz in USA (but frequently lower, e.g. 114V) and 220v at 50 Hz in most of Europe, or 230V at 50 Hz in the UK. Three-phase power, such as is available in conventional networks, for example fed into the networks by wind generators, or hydroelectric plants, or tidal or wave generators, is normally at 400v, with each phase being at 50 Hz and the three phases being at 120 degrees offset to each other.

Now we will consider using a preferred stack design with seven stack modules each having 30 cells on each side of a central plate, i.e. between one end plate of the stack and the central plate and between the central plate and the other end plate of the stack. I.e. the 30 cell sin series on each side of the central plate are connected in parallel.

If such a stack module is powered by a photovoltaic power source having a nominally 60v output then an ideal potential drop of 2v will be achieved across each cell of a group of thirty cells. A single stack module with porous electrodes of 80 mm×80 mm, i.e. a cross-sectional area of 64 square centimetres, can easily be operated at a current of 1 A per square centimetre. This applies when a cell design is used in accordance with FIGS. 1A to 4B below, or FIGS. 1A to 4 of the earlier application. This means that a single stack with seven stack modules with this design, i.e. 30 cells on each side of the central plate, stack modules with porous electrodes of 80 mm×80 mm area and operating at a current density of 1 A per square centimetre of electrode area can convert an input power of:

7 (number of stack modules)×60 (cells per stack module)×2v per cell×64 A per cell (8 cm×8 cm with 1A/cm² current density)=53.76 KW into oxygen and hydrogen.

If four such stacks are mounted in a rack and connected together, then the rack of stacks can dissipate over 200 KW of power! If the current density of the stacks can be increased to 1.5 A per square centimetre without overheating problems, which seems likely, then a rack of four modules of the design described could handle over 300 kW of input power and indeed irrespective of whether the nodules are connected in parallel, or in series, or with groups of stack modules in parallel and the groups in series.

If we now consider the examples given above for different power sources, then it can readily be seen how flexibly the design of such a rack can be utilised, i.e. a rack with four stacks of seven stack modules each, each with two sets of 30 cells in parallel.

For a 60v power source all 28 stack modules are connected in parallel and there is a potential drop of 2v across each cell. For a power source (USA) with a nominal 120v output two stacks, i.e. 14 stack modules are connected in parallel and the two groups of 2 stacks are connected in series. That means that there are always 60 cells in series. The potential drop over each cell is then 120v/60=2v per cell, within the ideal range of 1.8v to 2v per cell. In fact, that range corresponds to power inputs of 108 to 120v and it can thus deal easily with power fluctuations in this range without departing from the ideal cell voltage of 1.8v to 2v.

For a power source of 220v the stack modules of one stack, i.e. 7 stack modules, are connected in parallel and the four stacks of seven modules each are connected in series. Thus 120 cells are connected in series. The potential drop across each cell is now 220/120 which is 1.83v. well within the ideal range of 1.8v to 2v per cell. In fact that range corresponds to power inputs of 216v to 240v, so that the rack of four stacks of seven stack modules each can easily deal with both European and UK AC power supplies and can handle relevant power fluctuations in this range without departing from the ideal cell voltage of 1.8v to 2v.

For a power source of nominally 400v groups of four stack modules are connected in parallel, and seven such groups are connected in series. For the ideal range of 1.8v to 2v per cell that means the power source can have a voltage in the range from 378 to 420v.

Thus, one rack of four stacks each having seven stack modules can be connected together in different ways to handle input voltages of all normally expected kinds and up to 200 Kw or even 3200 kw, or possibly higher. This is actually a significant amount of power. Moreover, just one standardised stack can be used for most of the applications that arise in practise so that large economies of scale can be achieved.

Domestic photovoltaic systems typically have less than 20 kW peak power. Installations on bam roofs can easily reach 30 kW peak power, so that one stack of seven stack modules is more than able to cope with such power sources. For larger photovoltaic installations in fields or on the roofs of industrial buildings, one rack of four stacks of seven stack modules each could be a sensible design choice. For higher powers such as one or two MW, three or six racks can be connected together in parallel. Of course, these examples are not limiting and the numbers of stacks and stack modules in each stack can be varied at will.

For example, for small photovoltaic installations, or others with lower output voltages, stack modules of fewer cells or stacks with fewer stack modules than seven can be used if desired.

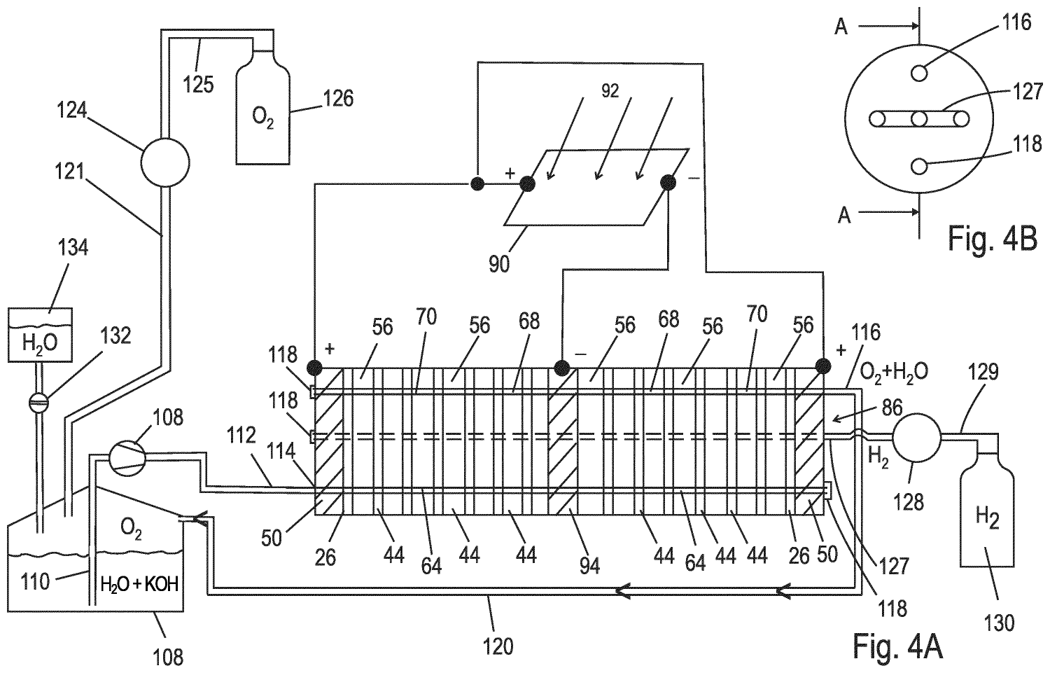

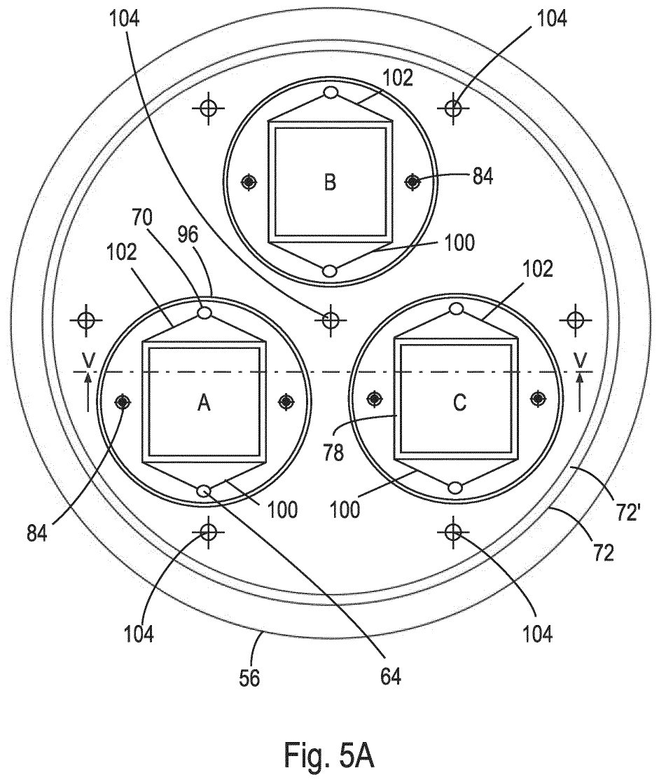

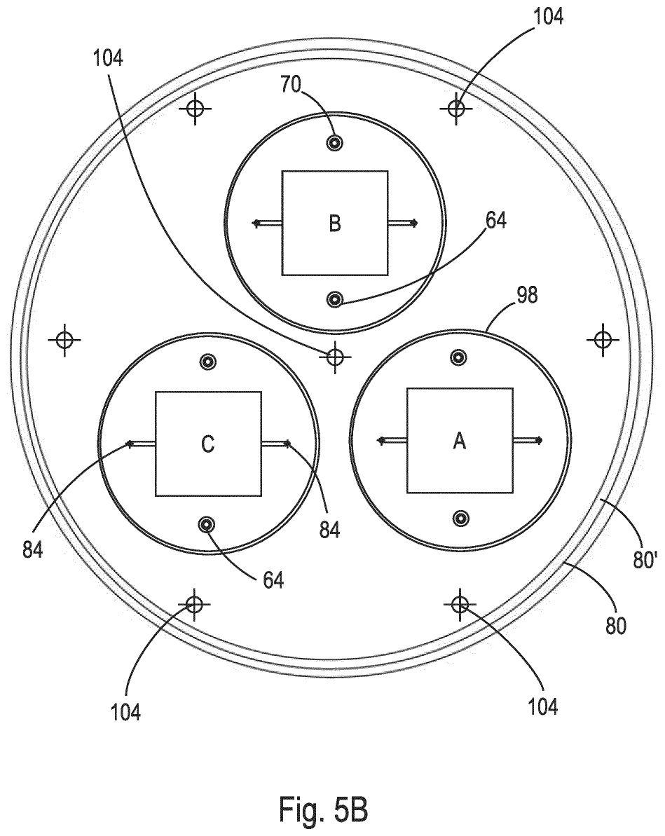

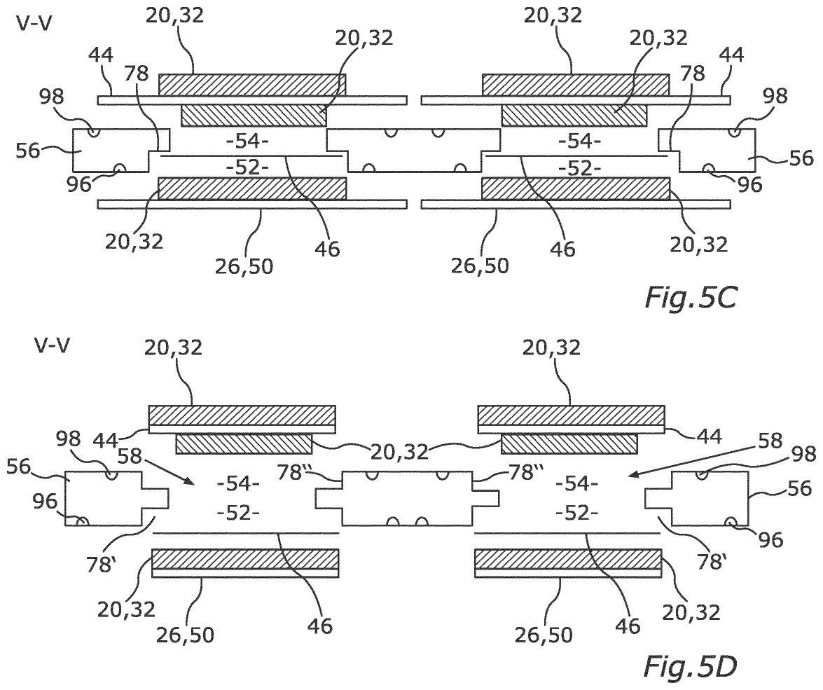

The invention will now be explained in more detail by way of example and with reference to the accompanying schematic drawings. In these drawings FIGS. 1 to 3 are basically the same drawings as in the earlier application DE 10 2021 117 722.7 which illustrate the preferred construction of a single stack module suitable for use in the present invention. FIG. 4 is a modified version of FIG. 4 of the earlier application showing schematics of the gas and liquid flows in the stack. FIGS. 5A to 17C illustrate preferred embodiments of the present invention each incorporating a plurality of stack modules.

More specifically the Figs show:

FIGS. 1A to 1E a simplified way of forming a first simple but expedient electrode in for use in a stack module of an electrochemical stack in accordance with the present invention,

FIGS. 2A to 2M a series of sketches illustrating the preferred way of manufacturing a preferred embodiment of an electrode for use in a stack module of an electrochemical stack in accordance with the present invention,

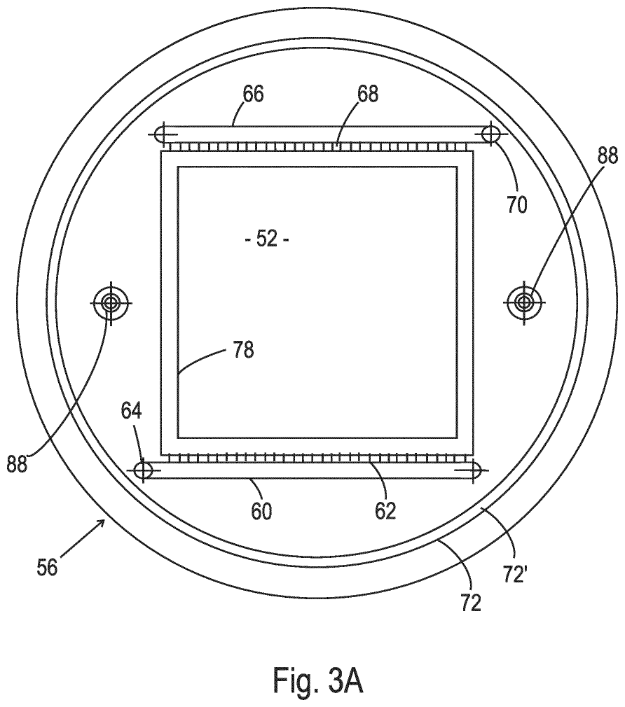

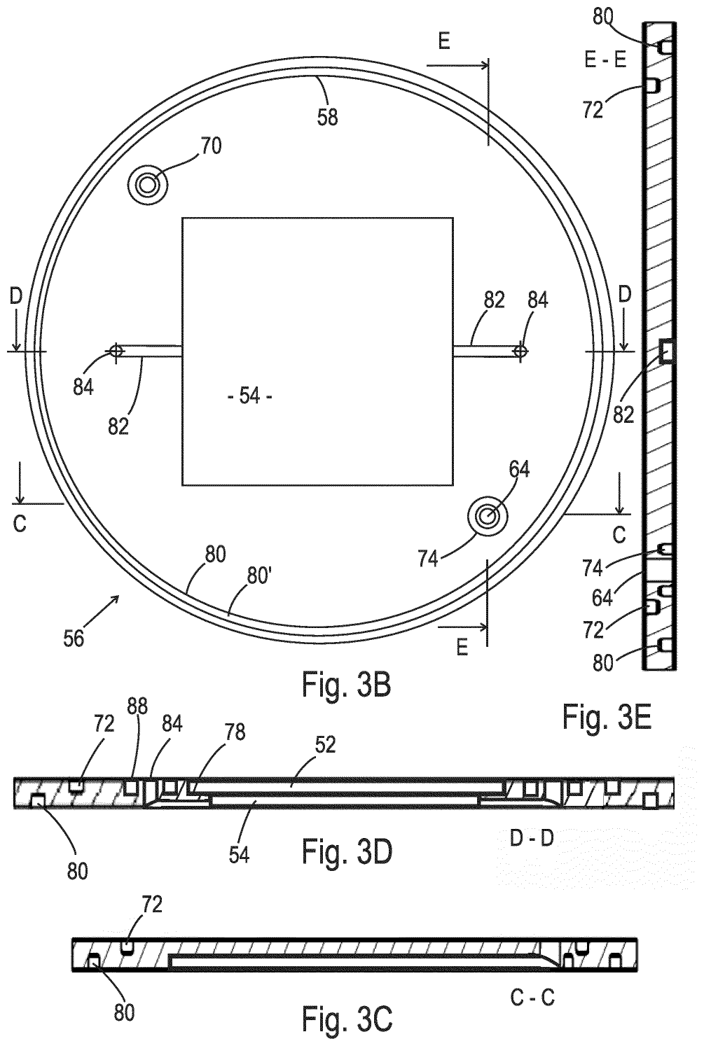

FIGS. 3A to 3E representations of an electrode holder in accordance with the invention of DE 10 2021 117 722.7 suitable for use in modified form in present invention, with FIGS. 3C to 3E not being to scale and increased in size in the direction perpendicular to FIGS. 3A and 3B to show the detail more clearly, more specifically

FIG. 3A is a plan view of the abode side of the holder,

FIG. 3B is a plan view of the cathode side of the electrode holder,

FIG. 3C is a section of the electrode holder in the section plane C-C of FIG. 3B

FIG. 3D is a section of the electrode holder on the section plane D-D of FIG. 3B and

FIG. 3E is a section of the electrode holder on the section plane E-E of FIG. 3B,

FIG. 4A is a highly schematic section of a preferred embodiment of a stack showing the connection of the stack to a DC electrical power supply, which can be formed by solar panels,

FIG. 4B is an end view of the stack of FIG. 4 showing the plane A-A in which the section of FIG. 4A is taken,

FIGS. 5A & B are drawings of the anode side and cathode side respectively of a holder such as is used in an electrochemical stack of an electrolyser as illustrated in FIG. 4, but adapted for use with three stack modules in accordance with the present invention,

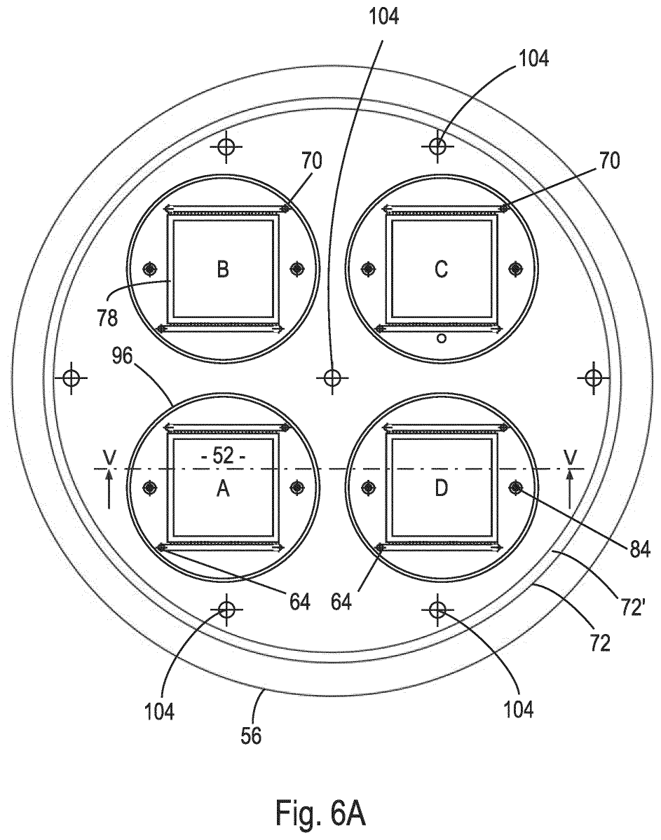

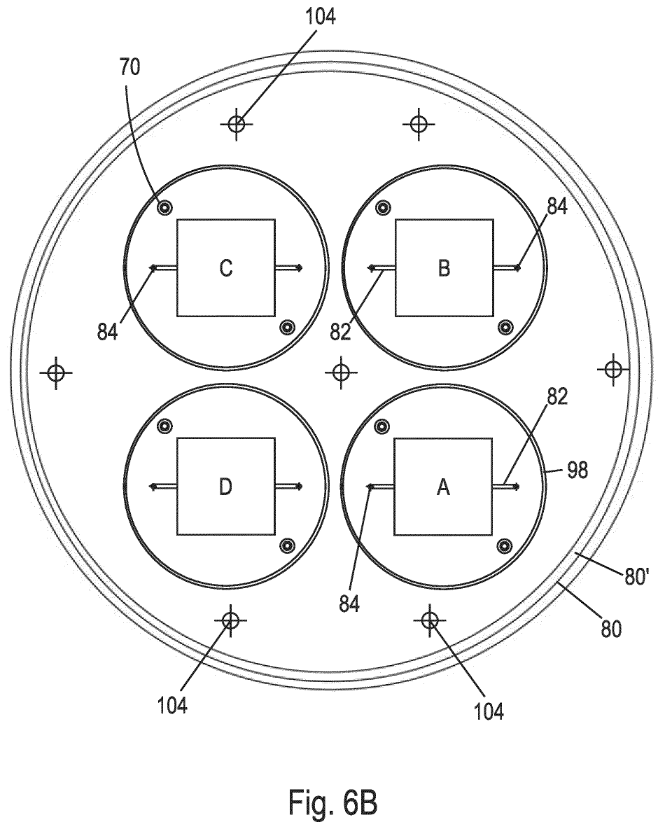

FIGS. 5C & 5D are sections generally on the plane V-V of FIG. 5A or the similar plane V-V of FIG. 6A showing two basic alternative layouts of a holder with associated electrodes and bipolar plates,

FIGS. 6A & B are drawings similar to FIGS. 5A and B but showing a holder for an electrochemical stack for an electrolyser adapted for use with four stack modules,

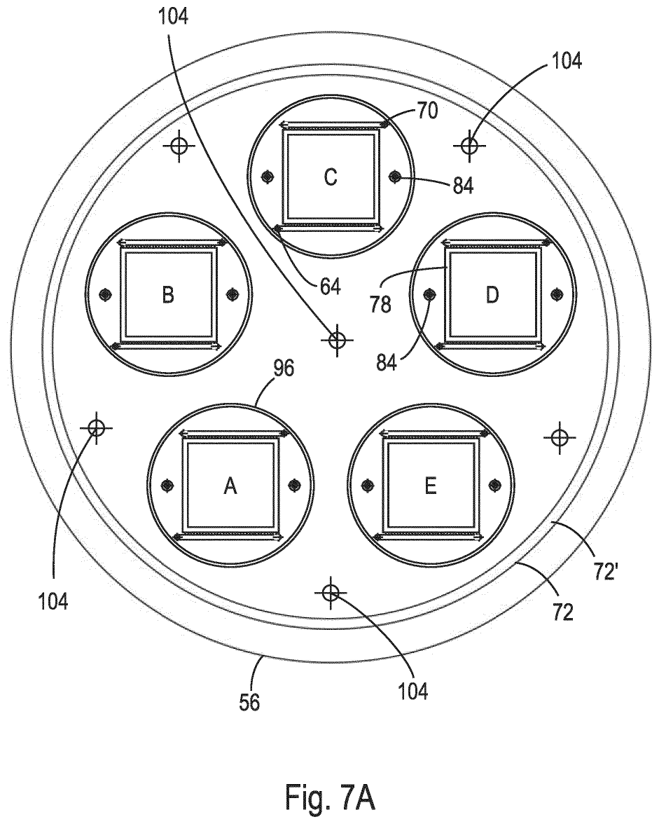

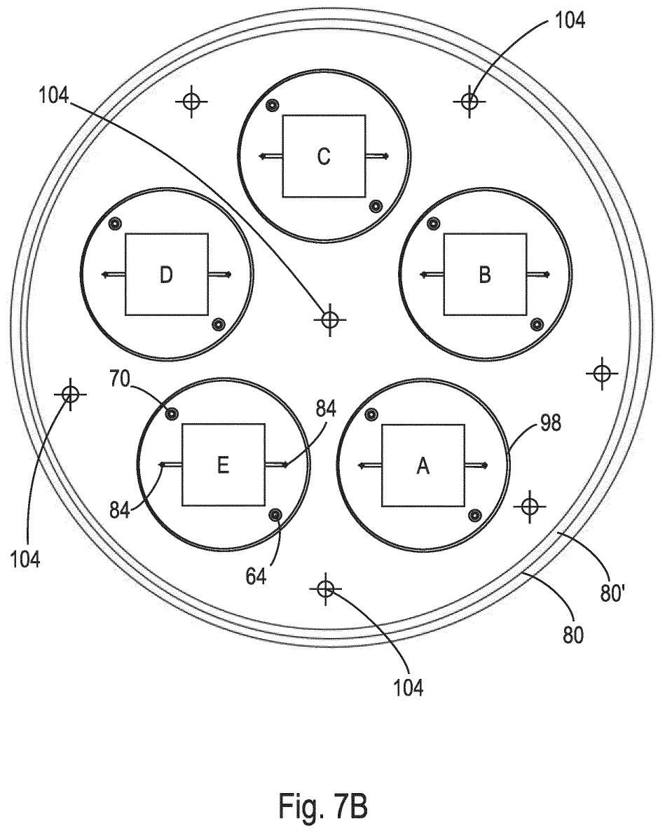

FIGS. 7A & B are drawings similar to FIGS. 5A and B of an electrochemical stack for an electrolyser but showing a holder for an electrochemical stack for an electrolyser adapted for use with five stack modules,

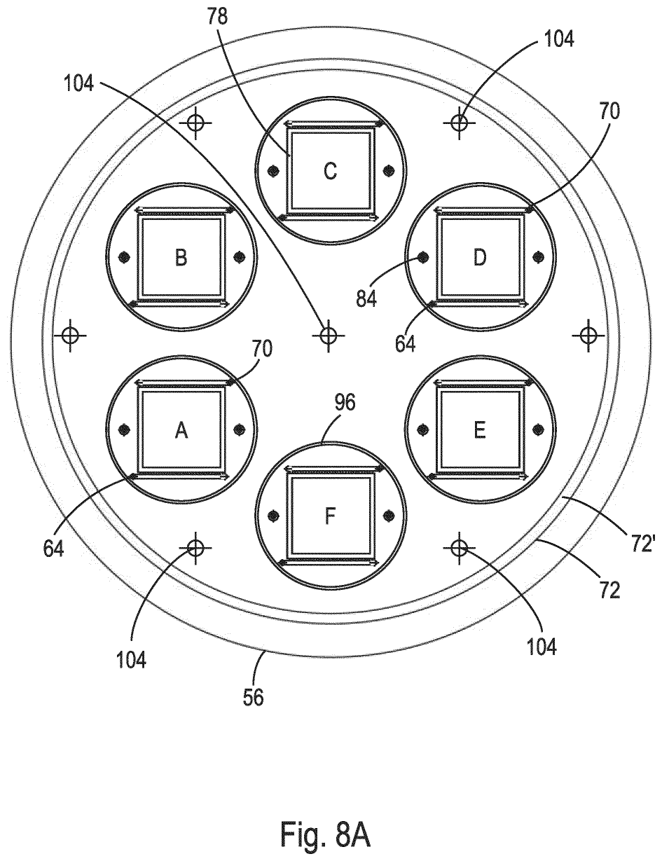

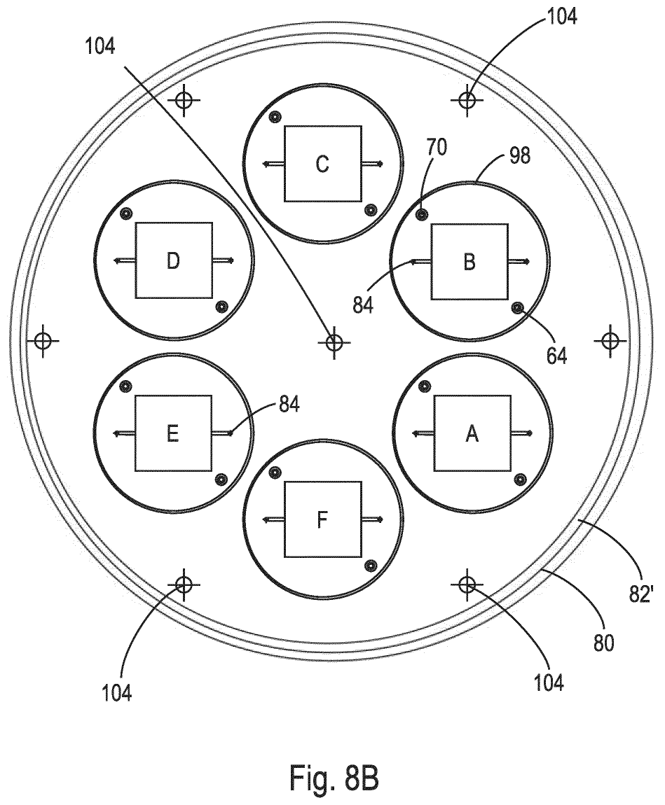

FIGS. 8A & B are drawings similar to FIGS. 5A and B but showing a holder for an electrochemical stack for an electrolyser adapted for use with six stack modules,

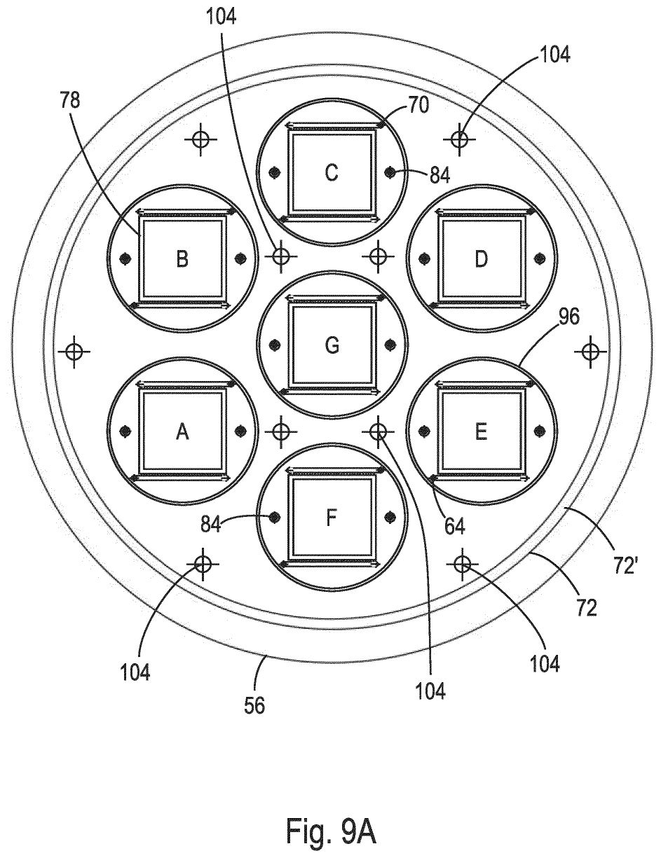

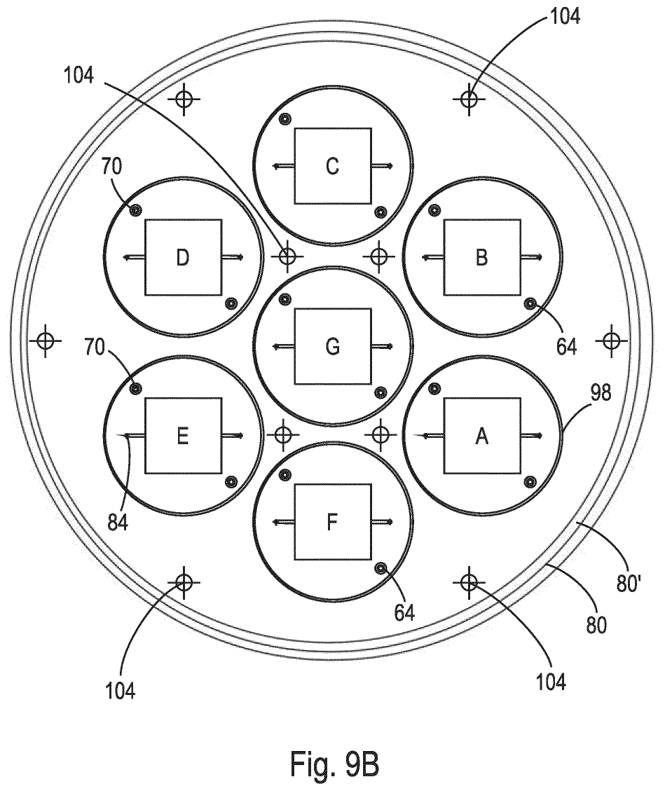

FIG. 9A & B are drawings similar to FIGS. 5A and B but showing a holder for an electrochemical stack for an electrolyser adapted for use with seven stack modules,

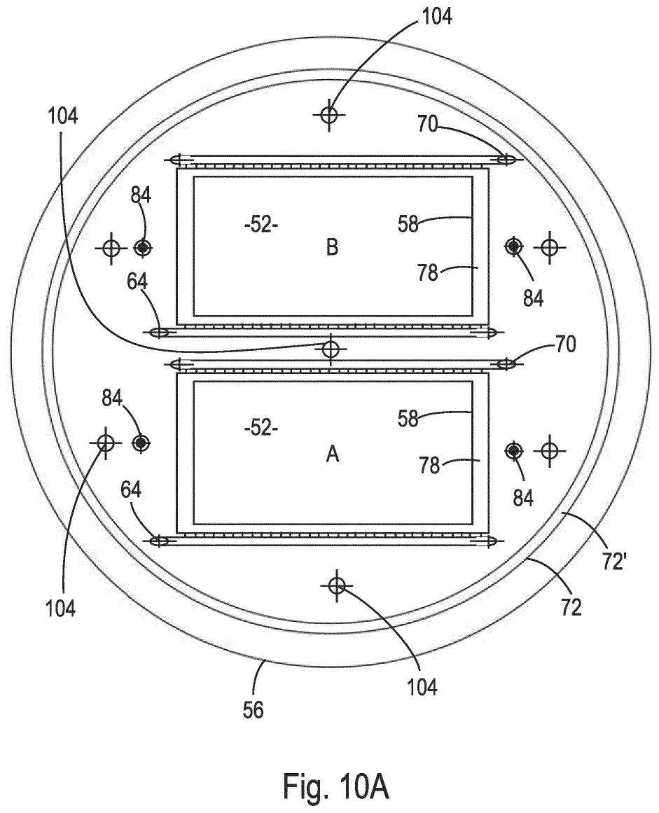

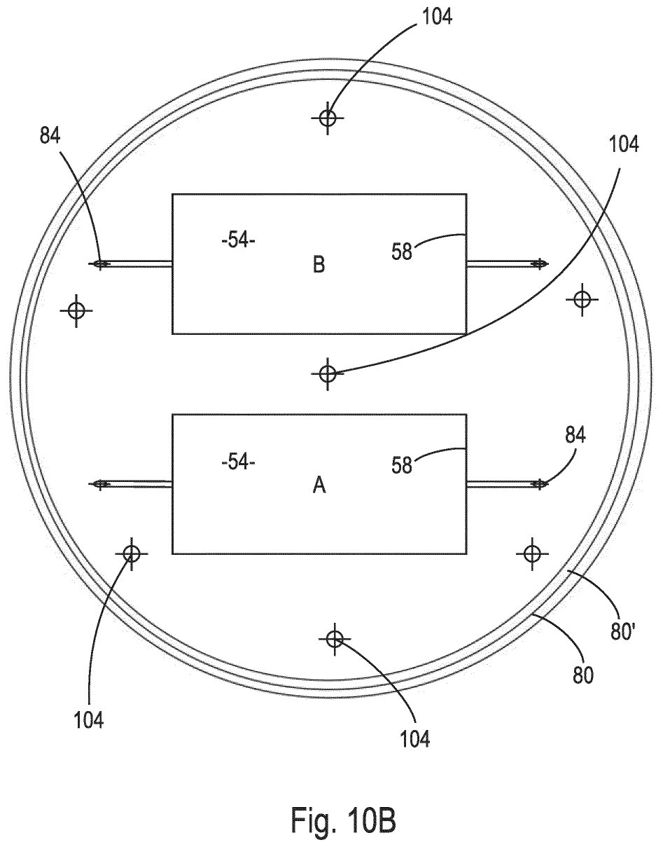

FIGS. 10A & B are drawings similar to FIGS. 5A and B but showing a holder for an electrochemical stack for an electrolyser having two stack modules,

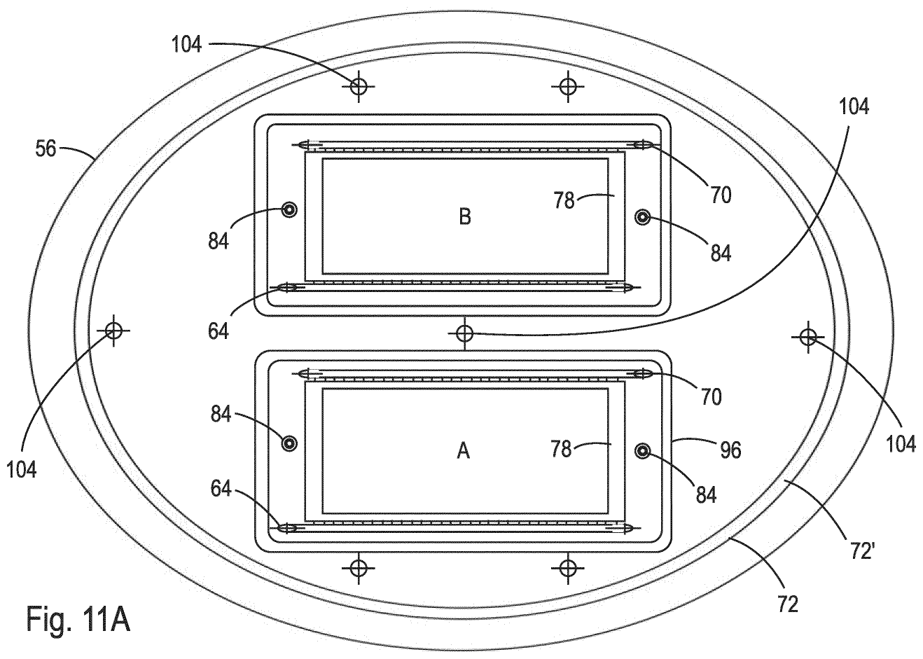

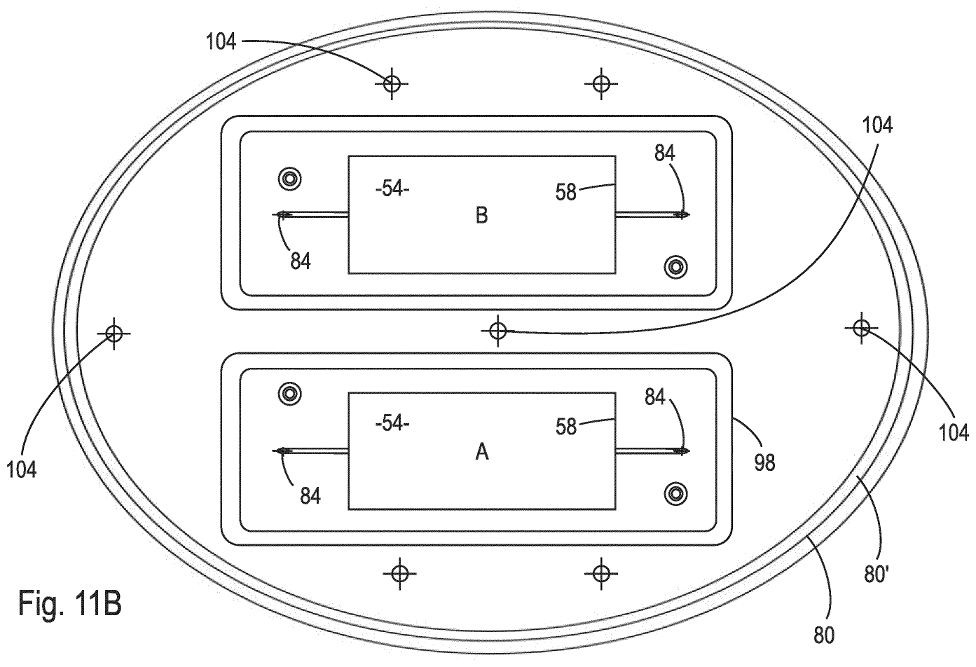

FIGS. 11A & B are drawings similar to FIGS. 10A and B but showing a holder having an elliptical outline,

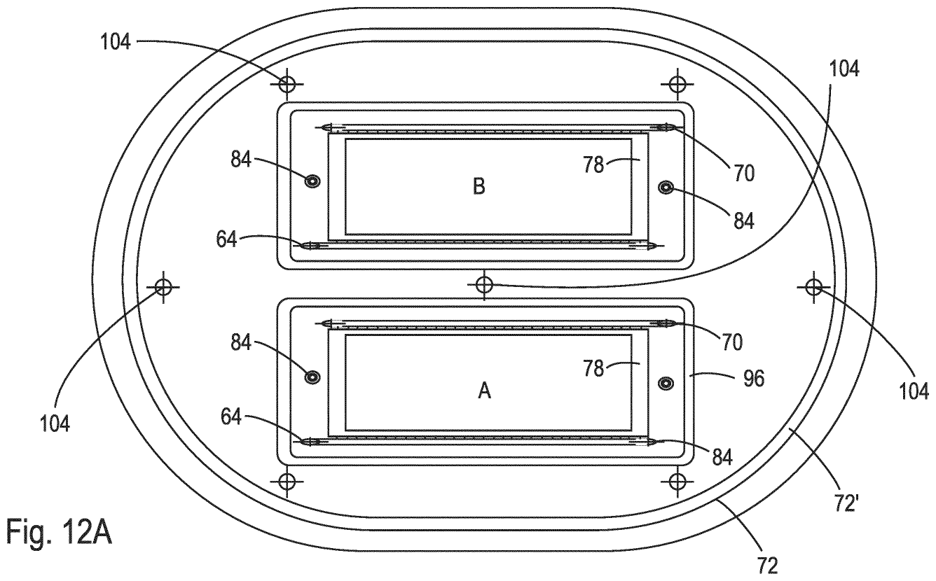

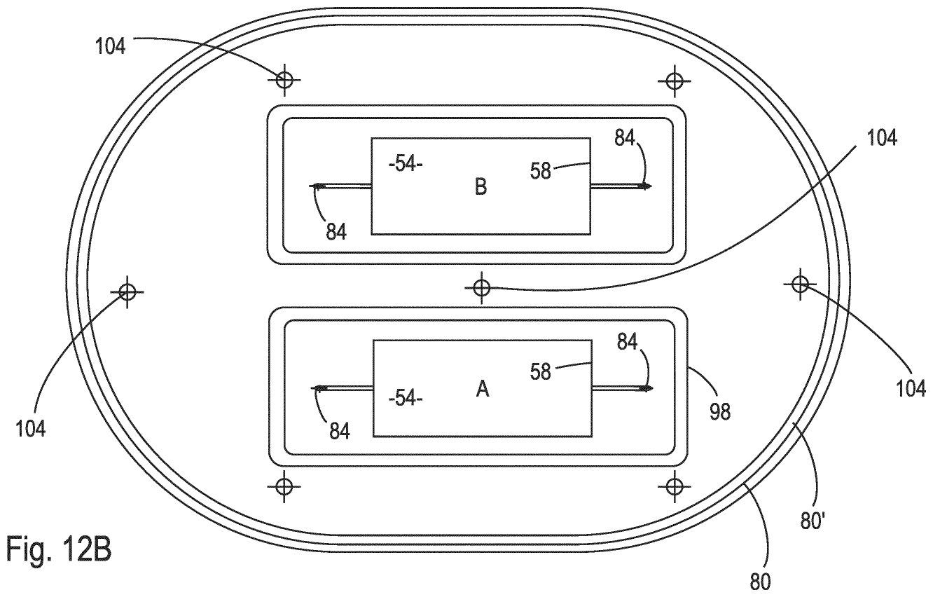

FIGS. 12A & B are drawings similar to FIGS. 11A and B but showing a holder having an outline formed by straight lines and curved lines,

FIGS. 13A & B are drawings similar to FIGS. 11A and B but having a polygonal outline here in the form of a hexagonal outline,

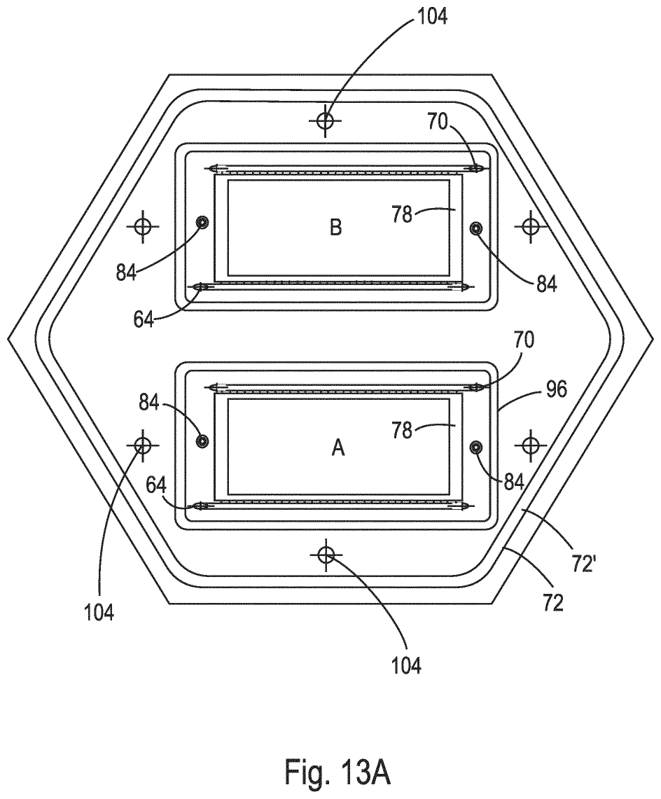

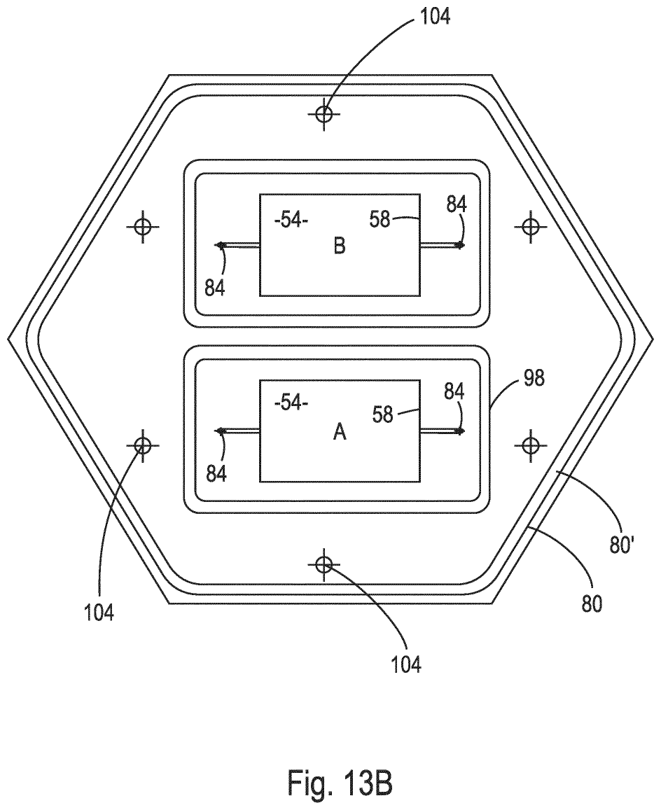

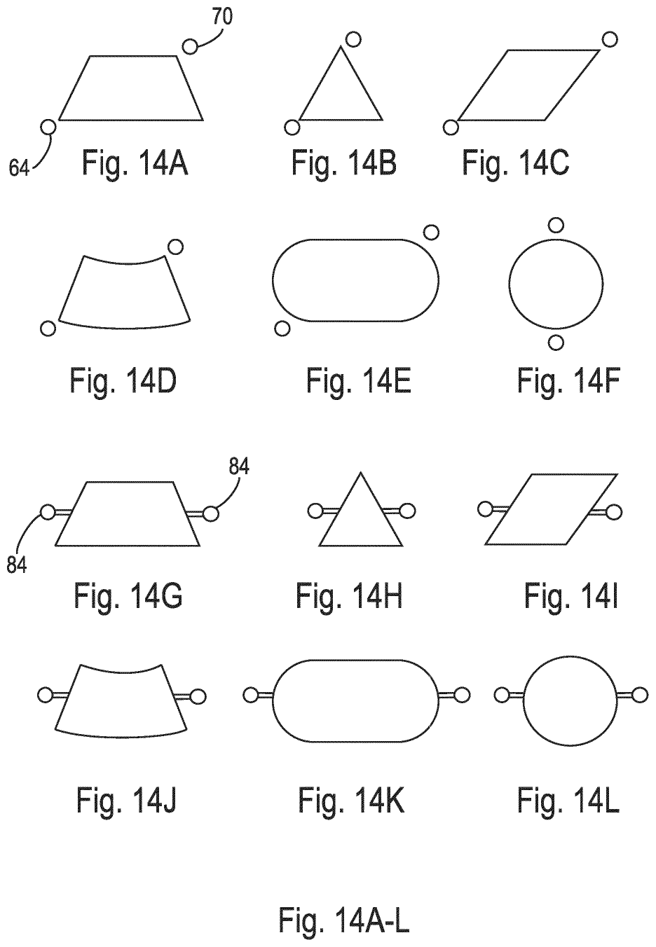

FIGS. 14A to L show a variety of possible alternative outlines for apertures in holders as in any of the preceding FIGS. 5 to 13,

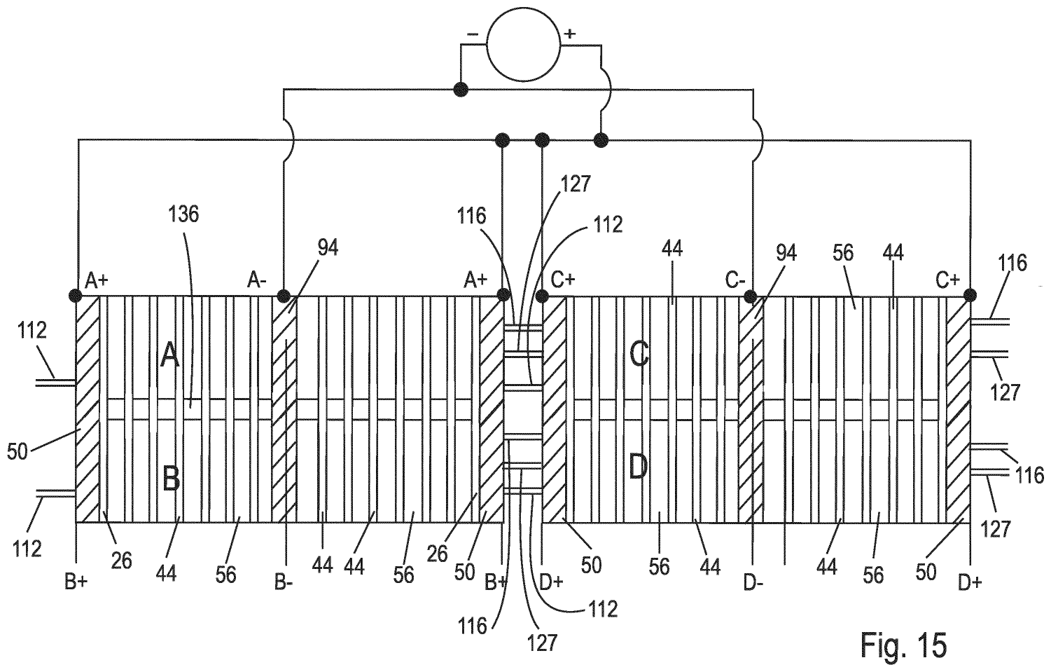

FIG. 15 us a schematic side view of an electrochemical stack of an electrolyser similar to that of FIG. 4 but having a plurality of stack modules,

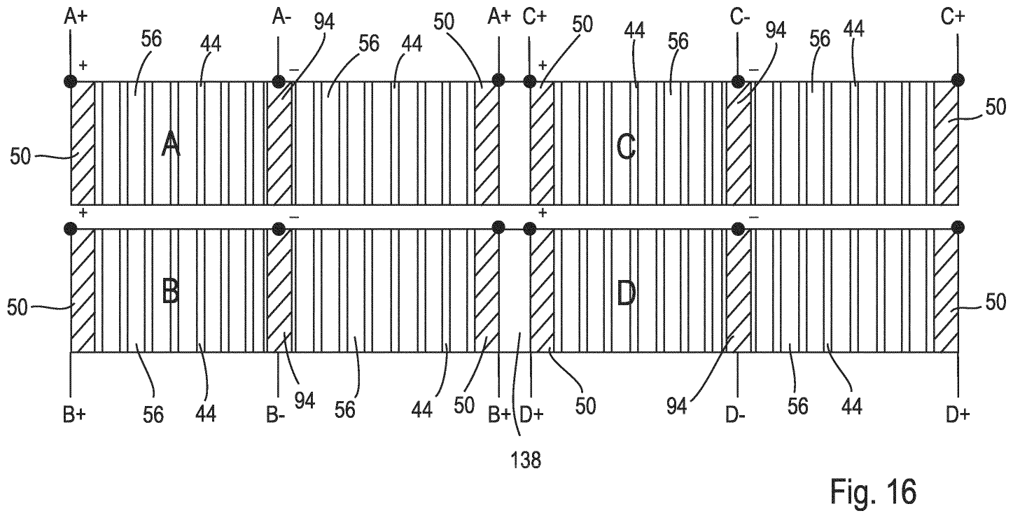

FIG. 16 is a schematic side view of an electrochemical stack of an electrolyser similar to that of FIG. 15 but having a plurality of stack modules with differently arranged bipolar plates and end electrodes,

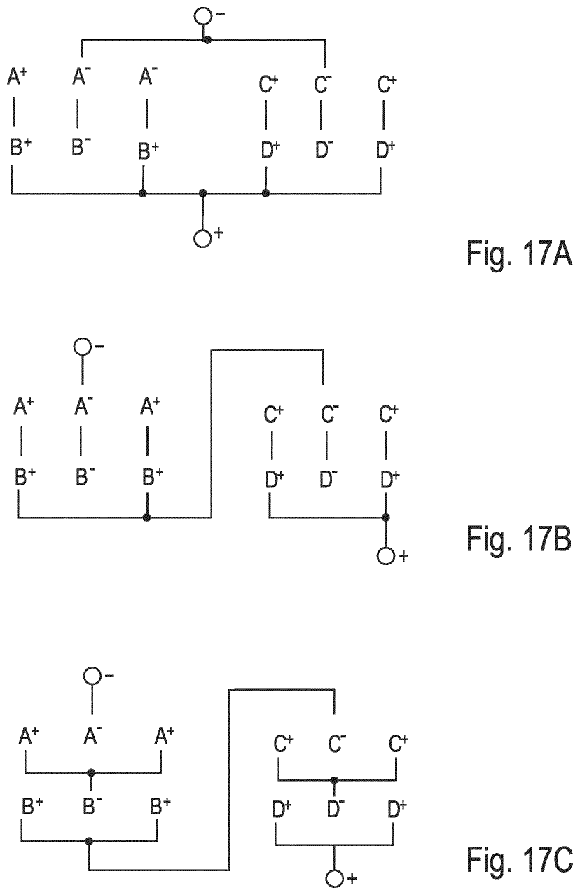

FIGS. 17A shows a schematic diagram of the equivalent circuit for the stack modules of FIG. 15 when all stack modules are connected in parallel,

FIG. 17B shows a schematic diagram of the equivalent circuit for the stack modules of FIG. 15 when pairs of stack modules are connected electrically in parallel and two pairs are connected electrically in series and

FIG. 17C shows a schematic diagram of the equivalent circuit for the four stack modules of FIG. 16 connected electrically in series.

Turning first to FIG. 1A there can be seen a schematic diagram of a mould 10 for forming an electrode assembly. The mould 10 has an internal base surface 12 which is planar and preferably polished to a mirror surface. In FIG. 1B a layer 14 comprising a slurry 14 of particles 16 in a binder medium 18 has been introduced into the mould 10 and been vibrated and/or subjected to a vacuum to extract air bubbles from the slurry and generate a homogenous layer.

The particles 16 can, for example, be nickel particles with a size in the range from <0.1 microns to 10 microns. The binder medium 18 can, for example, be an epoxy resin or a sugar or an organic polymer. In principle any binder medium can be used provided it is capable of being hardened or cured and removed by heating and evaporation, or by reduction by a reducing gas such as hydrogen at an elevated temperature.

If required to ensure clean separation of the partially cured or hardened layer 14 at a later stage, it is possible to treat the mirror surface at the internal base surface 12 of the mould 10 with a release agent (not shown) or to place a layer of a release material (also not shown) such as a plastic film of polyethylene or the like, or a wax paper, on the base surface 12.

The binder medium 18 can be partially cured or hardened so that it is still soft. As can be seen in FIG. 1C a layer of an electrically conductive mesh 20 having lower knuckles 22 is then placed onto the first layer 14 so that the knuckles 22 are wetted by the slurry 14 and the knuckles 22 are coated with the slurry 14. If desired the mesh 20 can first be rolled or calendared or ground to flatten the knuckles or at least some of them such as the lower knuckles 22 and the upper knuckles 24.

Following this step, as seen in FIG. 1D, a conductive metal plate 26 which overlaps the side walls 28 of the mould 10 is placed onto the upper knuckles 24 of the mesh 20 remote from said slurry. If desired a downward force can be exerted on the top of the metal plate 26 to ensure contact with the side walls 28 and the upper knuckles 24. The height of the side walls 28 then controls the thickness of the resulting assembly.

If desired the mesh 20 can previously be coated with a binder medium, or binder medium containing particles, so that the upper knuckles are bonded to the metal plate.

Thereafter, the binder medium can be partially hardened or fully hardened and, as illustrated in FIG. 1D removed from the mould to produce a first electrode assembly 30. In FIG. 1E the first electrode assembly 30 is inverted relative to FIG. 1D. Also, in FIG. 1E the electrode assembly 30 has been fully cured and sintered in a reducing atmosphere such as hydrogen gas in an oven under pressure to remove the binder medium and to sinter the components together. That is to say, the porous layer 32 formed from the layer of slurry 14 (now a sintered layer of metal particles), the layer of mesh 20 and the conductive metal plate 26 are sintered into the finished, fused, first electrode assembly 30.

This finished assembly 30 can be used in its own right as an anode or as a cathode and could, if desired, also be coated with a catalyst to form a catalytic converter.

The method described above thus results, as shown in FIG. 1E, in a first electrode 30 including at least an electrically conductive plate 26, at least one layer of an electrically conductive mesh 20 having knuckles 24 in fused electrical contact with the electrically conductive plate 26 and mesh passages 34 for the flow of an electrically conductive medium laterally through the mesh 20.

The electrode 30 also includes the porous layer 32 of electrically conductive material coating a surface of the at least one layer of electrically conductive mesh 20 remote from the conductive plate 26, in fused electrical contact therewith and having a planar surface remote from the electrically conductive plate 26. A pore size of the porous layer 32 is substantially smaller than a pore size of the mesh passages 34. It should be noted that the surface of the porous layer 32 remote from the conductive plate is planar after sintering but not actually smooth. Instead it has a roughness defined by the size of the sintered particles and the sizes of the open pores or interstitial spaces between the particles. This is actually very advantageous; it enhances the surface area of the porous layer in contact with the anionic exchange membrane which enhances the anionic exchange process. It also enhances the support of the anionic membrane so that it can readily handle significant pressure and pressure differences on its two sides without failing.

Moreover, the resulting surface roughness is fine but regular, which enhances the performance of the cell and ensures it is uniform across the full area of the cell, which maximises the cell output. The surface roughness also effectively increases the accessible surface area of the anionic exchange membrane which favours the flow of anions through the anionic exchange membrane

An electrode assembly 30 as described above can be perfectly satisfactory. However, a problem sometimes arises that the layer of conductive mesh 20 tears or cracks during the sintering process.

One way of avoiding this is to use first and second layers of an electrically conductive mesh 20, 36 as indicated in the method described with reference to FIGS. 2A to 2F. As seen in FIG. 2F the lower knuckles 22 of the first layer 20 are in fused electrical contact with the porous layer 32 and the first layer has first mesh passages 34 permitting lateral flow through the mesh 20. The second layer of an electrically conductive mesh 36 has lower knuckles 40 with second mesh passages 38 larger than said first mesh passages 34. The second layer 36 has upper knuckles 42 in fused electrical contact with the metal plate 26. In this way the first layer of mesh 20 can be made thinner by the use of finer wire and is thus finer than the second layer 36. This significantly reduces the danger of tearing or cracking of the first layer 20. The first and second layers of mesh are sintered together at points at which upper knuckles 24 of the first layer contact lower knuckles 40 of the second layer 36.

The way in which an electrode of this kind is manufactured will now be described, again with reference to FIGS. 2A to 2F. In these Figures the same reference numerals will be used as in FIGS. 1A to 1E for components having the same or similar function and the description used for components in FIGS. 1A to 1E will also be understood to apply for the components of the embodiment of FIGS. 2A to 2F, unless something is stated to the contrary. This convention will also apply to the description of all other components of the subsequent figures for components identified by common reference numerals. That is to say the function and arrangement of components identified by common reference numerals will be understood to be the same, unless something to the contrary is stated, in order to simplify the further description.

As can be seen from FIGS. 2A to 2C the steps shown there are largely identical to the steps of FIGS. 1A to 1C. Thus, the mould 10 of FIG. 2A is largely identical to the mould 10 of FIG. 1A except that the side walls 28 are rather taller. FIG. 2B again shows the layer of slurry 14, which is the same as the layer 14 of slurry of FIG. 1B. FIG. 2C also shows a layer of electrically conductive mesh, here also identified with the reference numeral 20, which has lower knuckles 22 in contact with the layer 14 of slurry.

The only difference relative to FIG. 1C is that the mesh 20 is a finer weave of a finer wire and less thick than the weave of the mesh 20 of FIG. 1C (although this is not apparent from a comparison of FIGS. 1C and 2C in order to avoid unnecessarily complicating the drawings). The mesh passages 34 for lateral flow through the mesh 20 thus have a smaller pore size relative to those of the mesh 20 in FIG. 1C.

In FIG. 2D the second layer of electrically conductive mesh 36 has been placed with at least some of its lower knuckles 40 in contact with at least some of the upper knuckles 24 of the conductive mesh 20. In FIG. 2E the conductive plate 26 is placed on top of the upper knuckles 42 of the second layer of mesh 36. Once the binder has been cured or fully hardened the electrode assembly of FIG. 2E can then be released from the mould and heated in an oven to evaporate or reduce the binder and to sinter the components together.

Thus, the upper knuckles 42 of the second layer of mesh are sintered to the conductive plate 26, the lower knuckles 40 of the second layer of mesh 36 are sintered to the upper knuckles 24 of the first layer of mesh 20 and the lower knuckles of the first layer of mesh are sintered to the porous layer 30. Also, as in other embodiments, the weft and warp threads of each layer of woven mesh are sintered together at their points of contact.

If necessary the wefts and warps of each layer of mesh can also be coated with slurry prior to curing and sintering so that conductive metal particles are sintered to the meshes and also at the contact points to the metal plate.

The resulting first electrode assembly 30 is shown in FIG. 2F. This first electrode assembly is used, as will now be described, as the starting point to form a bipolar plate with first and second electrode assemblies on opposite sides thereof.

The way this is done will now be explained with reference to the further FIGS. 2G to 2L. First the first electrode assembly shown in FIG. 2F is inverted as shown in FIG. 2G. Then the steps shown in FIGS. 2B to 2D are repeated, generally using a new mould 10 fractionally larger (or smaller) than the previous mould 10 using a new layer of slurry 14, a new mesh 20 and a new mesh 36. The point of using a new larger or smaller mould 10 (not shown) is to ensure the electrode used for the anode space is fractionally larger than that used for the cathode space (or vice versa) so that the electrode for the anode space can press the anionic exchange membrane 46 against the recessed square seat 78 of the holder 56 discussed below with reference to FIGS. 3A to 3E.

Then, as shown in FIG. 2K the inverted electrode assembly of FIG. 2G is placed on top of the upper knuckles of the second mesh 36. Again, the side walls of the mould control the thickness of the electrode assembly below the metal plate 26 forming the bipolar plate 44.

After curing of the binder medium, the electrode assembly, i.e. the bipolar plate 44 with first and second porous electrodes 30 on either side is removed from the mould and fully cured and sintered as described above to result in the bipolar plate 44 and the associated porous electrodes of FIG. 2L.

Instead of using the first electrode assembly 30 of FIG. 2F for the construction of the bipolar plate, the first electrode assembly 30 of FIG. 1E could be used. Moreover, it is not essential that a second mesh 36 is used in the step of FIG. 2J. That step could be omitted. This is also the case when the first electrode assembly 30 of FIG. 2F is used.

Thus, it is not essential that the electrode structure at the anode and cathode sides of the bipolar plate are identical. In particular, since there is a flow of conductive medium or electrolyte through the anode spaces, a higher flow area for lateral flow is important there. In the cathode spaces there is basically only a lateral flow of hydrogen gas that is generated in the moist environment, so that only a smaller flow area for lateral flow is required there.

In the following the formation of an electrolyser stack 48 will now be described with reference to FIG. 2M.

Starting from the bottom a first metallic plate 50 is provided which can, for example, as shown here, be the anode connection for the stack. On top of this there is placed a first electrode assembly 30 in accordance with FIG. 2G (or a first electrode assembly 30 in accordance with FIG. 1E-not shown here) and then a sheet of an anionic exchange membrane 46 is placed on the free-standing planar surface of the porous layer 32.

Next a bipolar plate 44 in accordance with FIG. 2L, with electrode assemblies 30, on opposite sides thereof, is placed on the anionic membrane 46. A further anionic membrane 46 is then placed on the freestanding planar surface of the electrode assembly on the bipolar plate 44. The process described immediately above is then repeated for any desired number of bipolar plates 44 in accordance with FIG. 2L. Only two such bipolar plates 44 are shown here for the sake of simplicity.

Thereafter, a final anionic exchange membrane 46 is placed on the freestanding surface of the uppermost electrode of the bipolar plate and a further first electrode assembly, e.g. in accordance with FIG. 2F (or FIG. 1E—not shown) is added. Finally a second metallic plate 50, which can be the cathode connection to the stack, is added and the stack pressed together by forces acting in the direction of the arrows. These forces can be generated by clamping bolts or by spring pressure or by mechanical pressure or otherwise.

Thus, the resultant stack has anode spaces 52 and cathode spaces 54 on opposite sides of each anionic membrane 46.

In practise the electrode assemblies of the stack are not just arranged one above the other but are instead arranged next to one another in special holders 56 which will now be described with reference to FIGS. 3A to 3E.

For the sake of simplicity, the electrodes for the cathode and anode spaces have been drawn to the same size in FIG. 2M. However, it will be appreciated that the electrodes in the anode spaces 52 are actually fractionally larger than the electrodes in the cathode spaces 54 so that the electrodes in the anode spaces 52 can press the anionic exchange membranes 46, which are of the same width and length as the electrodes for the anode spaces 52, against the square seats 78 provided in and around the square openings 58 in the holders

In a practical example, which is in no way to be taken as a restriction on the size of the electrolyser cells, the square opening 58 in the holder 56 is 160 mm in width and length, the holder 56 is 350 mm in diameter and has an axial depth of 6 mm which equates to the depth of a cathode space plus the depth of the anode space, which is typically the same as the depth of the cathode space, optionally plus the thickness of the bipolar plate if this is designed to sit in a recess in the holder rather than extending across the whole width of the holder, which is also possible.

This thickness may be less if the anodes and cathodes are of different design, e.g. a thinner cathode with just one mesh 20 and a thicker anode with first and second meshes 20, 36. The thickness of the anionic exchange membrane is typically about 100 microns and can be ignored as the porous electrode assemblies in the anode and cathode spaces can be compressed by this amount on pressing the cells of the electrolyser stack together. The width of the recessed seat 78 is, for example, 10 mm on each side of the square opening 58.

FIG. 3A shows a plan view of the anode side, the A-side, of the insulating holder 56, typically made of an injection moulded plastic such as polyamide or HPPE (high density polyethylene). As can be seen the holder 56 is circular in shape and has the square central opening 58. Below the square opening there is a transverse feed groove 60 which communicates via a plurality of short feed passages 62 with the anode space 52 of an electrode (not shown but which would be arranged in the square opening 58 at the larger side adjacent the square seat 78). The bottommost transverse groove 60 communicates with a feed passage 64 for electrolyte extending axially through the holder 56. Above the square opening 58 there is a symmetrically designed arrangement of a transverse outlet groove 66 which also communicates with the anode space 52 of an electrode in the square opening 58 via short outlet passages 68 and which leads to an outlet passage 70 for electrolyte and oxygen extending axially through the holder 56. The reference numeral 72 indicates a circumferential groove sized to receive an O-ring 72′ and reference numerals 74 and 76 show further grooves for O-rings surrounding the feed passage 64 and the outlet passage 70 respectively.

Around the square opening there is a square recessed seat 78 at about half the axial height of the holder 56, as can be seen from FIG. 3D.

In use the anode side of the holder 56 is placed onto a first electrode assembly 20 so that the freestanding porous surface with the membrane on it lies at the level of the square seat 78 on the seat 78. The cathode side of a bipolar plate is then placed so that its planar porous surface lies on the anionic membrane within the opening of the holder with the bipolar plate lying on the holder 56. At the cathode side of each holder 56 there are transverse grooves 82 and axial passages 84 for collecting hydrogen generated in the cathode spaces 54.

The metal plate 26 of the first electrode has the same circular shape and size as the holder 56 and engages against the underside of the holder 56 in this example. It is sealed there by an O-ring 80′ inserted into an O-ring groove 80 shown at the cathode side of the holder 56 as seen in FIG. 3B. It will be noted that the two O-ring grooves 72 and 80 are concentric but radially offset so that the holder 56 is not unduly weakened by them. The bipolar plate 44 seals against the anode side of the next holder 56 at an O-ring 72′ provided in the groove 72. Thus, each holder 56 houses the anode and cathode spaces 52, 54 of one cell of a stack and each holder 56 is arranged either between a conductive metal plate 26 of a first electrode 30 and a bipolar plate 44, or between two consecutive bipolar plates 44. This only applies if the bipolar plates are not recessed within the holders, which is also possible.

Holes or bores (not shown here but in FIG. 4A) are provided in the electrode plates 26 and bipolar plates 44 which respectively align with the main feed passage 64 for the supply of electrolyte to the anode space, with the main outlet passages 70 for removing electrolyte and oxygen from the anode space 52 and with the axial passages 84 for removing hydrogen from the cathode spaces 54.

Corresponding holes or bores are provided in at least one of the end plates for the feed of electrolyte into the main feed passages 64, for the removal of electrolyte and oxygen from the main outlet passages 70 and for the removal of hydrogen from the axial passages 84.

Turning now to FIGS. 4A and B there can be seen a schematic illustration of an electrolyser stack 86, here arranged horizontally, with end plates 50, end-electrodes 30, bipolar plates 44 and electrode holders 56 containing anodes and cathodes and anionic membranes 46.

The horizontal arrangement is preferred since the anode spaces 52 are then arranged vertically, as shown in FIG. 4A and thus O₂ generated in the anode spaces can rise to the top of the anode spaces due to gravity and buoyancy effects and the oxygen is efficiently removed from the anode spaces 52 and the stack 86.

At the centre of the stack 86 there is a connection plate 94 which acts as a monopolar cathode plate having electrode structures on both sides. The electrode structures cannot be seen completely in FIG. 4A as the porous elements and the anionic exchange membranes are located within the holders 56 as discussed above. Only the conductive nonporous metal plates 26 of the electrodes 30 are shown in FIG. 4A. The central connection plate 94 does not have to be as thick as an end plate 50 as shown, but could be thinner and indeed could be just as thick as a regular bipolar plate 44 providing an electrical connection can be made to it.

In the illustrated embodiment there are thus twelve holders 56 each surrounding an electrolyser cell having an anode and a cathode with an anionic exchange membrane disposed between them as described in connection with FIG. 2M. There is no specific limit on the number of holders 56, i.e. of electrolyser cells in the stack 86 and there could be more or fewer than shown, but always the same number of holders 56 and cells on both sides of the central connection plate 94.

Also, it should be noted that the cells on the right side of the central connection plate are arranged the other way around from the cells on the left side of the central connection plate 94. Put another way, the cathode and anode spaces 54, 52 are reversed. I.e. mirror symmetry is present on the two sides of the central connection plate. This means that either two different types of holders 56 with mirror symmetry have to be provided at the two sides of the central plate 94, or a symmetrical design of holder has to be chosen which can be used either way around.

An electrolyser needs a DC power source of some kind and in the present embodiment this is formed by a photovoltaic panel 90 on which sunlight indicated by arrows 92 falls. The solar panel in this embodiment has a maximum outlet voltage of 12V. The positive side of the power supply is connected to the left-hand end plate 50 and to the right-hand end plate 50, which thus form anodes. The negative side of the power supply is connected to the central connection plate 94 which is thus the central cathode. This arrangement has the result that the electrolyser cells to the right and left of the central plate are connected electrically in parallel so that a maximum outlet potential of 12V (in this case) acts across two groups of six cells. I.e there is a potential drop of a maximum of 2V across each electrolyser cell (depending on the intensity of the incident sunlight).

No power is provided to the bipolar plates 44, instead these adopt a floating potential due to the electric field in which they are located, so that the desired potential drop in the range from 1.8 to 2 volts arises across each cell. Each bipolar plate 44 acts as an anode for one cell and as a cathode for the adjacent cell, hence the name bipolar plate. It will be appreciated that in a stack or stack module in accordance with the present invention, the electric field lines extend generally perpendicular to the planes of the end electrodes, to the planes of the bipolar plates and to the plane of the central electrode. This has the special advantage that the magnitude of the electric field does not place any significant restriction on the number of cells in each stack module or on the number of stack modules in each stack and in particular does not lead to exceedingly long stacks or stack modules. This is in sharp contrast to the design of U.S. Pat. No. 6,383,347 where the electric field extends parallel to the planes of the electrodes. Increasing the number of cell blocks in such a design would lead to an inordinately long and impractical design.

It should be noted that, ion the stack of the present invention, electrolyte, e.g. purified water containing KOH ions, flows through the anode spaces of all the cells, but the cells to the right of the central cathode are arranged the other way around from the cells to the left of the central cathode to reflect the opposite direction of the electric field. This means that the holders either have to be provided with extra bores to ensure the flow of electrolyte through all anode spaces or the holders 56 on the right of the cathode have to be made with mirror symmetry relative to those to the left of it. One way of doing this, which is assumed to be used here, as is evident from the drawing of FIG. 4B, is shown in FIGS. 5A and B.

The electric fields between the central cathode and each of the end anodes mean that the bipolar plates adopt floating potentials so that there is a maximum potential of 2V for each cell. This arrangement not only leads to higher electric fields in the electrolyser but also minimizes the energy loss due to an external magnetic field. These two factors greatly enhance the performance of the stack.

There is no restriction on the outlet power of the photovoltaic panels and the stack is basically self-regulating in the sense that the electrolyser will convert all power received from the solar panels into hydrogen and oxygen. This happens irrespective of whether the solar panel(s) is or are generating the maximum power or a lesser amount if the light intensity is less than the design maximum, which will frequently be the case. Naturally the electrolyser must be sized to exploit the maximum amount of power from the solar panel(s) and will simply generate less hydrogen and oxygen as the power delivered reduces.

If it is not possible to utilise the maximum current output of the DC-source in one stack comprising a plurality of stack modules then a number of stacks each comprising a plurality of stack modules can be provided and can be connected together in parallel and/or in series as appropriate to obtain a voltage drop across each stack module in the desired range and to share the available power in between the stack modules so that each is running at or slightly below the maximum current it can convert into hydrogen and oxygen.

FIG. 4A also shows a pump 106 for pumping electrolyte through the anode spaces 52 and it can also be driven from the power received from the solar panel(s) as can all other electrical components associated with the stack 86.

The pump 106 draws the electrolyte comprising distilled water containing KOH ions from a container 108 via tube 110 which extends almost to the bottom of the container 108. The pump delivers the electrolyte via a feed line 112, which feeds the electrolyte into an inlet 114 and into the inlet passages 64, which extend right the way through the bottom of the stack 86 including through the end plates 50, the electrodes 26, the holders 56 and the bipolar plates 44 as well as through the central connection plate 94.

At the lower right-hand side of the stack the bore 64 through the end plate 50 is closed by a plug 118. This allows the pressure delivered by the pump 106 to pump the electrolyte vertically upwardly through all the anode spaces 52 and the porous structures provided there, to the aligned outlets passages 70. The aligned outlet passages 70 again form part of a continuous bore extending through the endplates 50, the electrodes 26, the holders 56, the central connection plate 94 and the bipolar plates 44 to an outlet at the top right-hand side of end plate 50 and into a return line 120. The anode spaces 52 are thus all connected in parallel for the flow of electrolyte.

Return line 120 returns the mixture of electrolyte and oxygen leaving the stack to the sealed container 108, where the mixture separates via gravity into electrolyte at the bottom of the sealed container 108 and oxygen at the top of the container 108. The oxygen could be drawn off from the container 108 via a line 121 by a pump 124 which feeds the oxygen through a line 125 into a collector 126 shown here schematically as a gas bottle.

However, this is not the preferred arrangement since it is very difficult to compress oxygen as the slightest trace of fat, for example from a person's fingers, can lead to a horrific explosion. In fact, most electrolysers simply dump the oxygen into the atmosphere and do not seek to collect it. This is also possible here. Another alternative would be to provide a non-return valve, also schematically indicated here by the reference numeral 124 (which is now no longer a pump). The non-return valve 124 allows the collector 125 to be filled to a pressure set by the non-return valve. However, as stated, it is simpler and cheaper to discharge the oxygen into the atmosphere.

The continuous bore 70 extending through the end plates 50, the electrodes 26, the holders 56 and the bipolar plates 44 as well as through the central connection plate 94 is closed at the upper end of the left-hand end plate 50 by another plug 118.

The design just described means that the end plates 50, the central plate 94, the electrodes 26 and the bipolar plates 44 can all have the same hole pattern with respect to the anode spaces 52.

The hydrogen generated in the cathode spaces 54 passes through the aligned outlet passages 84. These are again parts of continuous bores extending through the end plates 50, the electrodes 26, the holders 56, the bipolar plates 44 and the central electrode 94. Because these two continuous bores are outside of the section plane of FIG. 4A as illustrated at A-A in FIG. 4B, and are arranged behind one another in this drawing, they are only shown as broken lines representing the aligned outlet passages 84 in the holders 56. It will be appreciated that the left-hand ends of these passages are also closed by plugs 118. The outlet ends are connected to a line 127 leading to a pump 128 for hydrogen which feeds the hydrogen via a line 129 into a collector 130, again schematically illustrated as a gas bottle.

The use of a pump 128 for the hydrogen is possible but not actually preferred, since pumps can leak and also require input power to operate. A much more favoured design is to replace the pump 128 by a non-return valve, also shown by the reference numeral 128, which now is no longer a pump. The non-return valve 128 controls the pressure to which the hydrogen collector can be filled. Of course, such a design means that the pressure in the cathode spaces can increase up to the design pressure of the gas collector 130. However, this is entirely possible and one advantage of the stack of FIG. 4 with relatively small areas of the electrodes is that it can readily run at high pressures without having to use unnecessarily massive clamping bolts and without having to fear failure of the anionic membranes 46.

Again, the hole patterns in the end plates 50, the electrodes 26, the holders 56 the bipolar plates 44 and the central connection plate 94 are all the same and symmetrically disposed. As a result, the components can be made very cost effectively. The end plates 50 and the central connection plate 94 can be identical. The bipolar plates 44 can also all be identical, as can the electrodes 26 and the holders 56. This design assumes the inlet and outlet bores 64 and 70 for the anode spaces are symmetrically placed as indicated in FIGS. 4A and B and as shown in the example of FIGS. 5A and 5B.

As the electrolyte is progressively converted into oxygen and hydrogen the level of electrolyte in the sealed container 108 falls progressively and needs to be topped up from a reservoir 134 via a metering valve 132. If required a pump (not shown) may be needed for this, depending on the pressure prevailing in the sealed container 108. Also, it is necessary to periodically check the KOH concentration within the electrolyte because H₂O gets lost as a main part of the electrolysis process.

A particularly preferred weave, especially for the mesh having larger mesh passages, is a so-called five shaft Atlas weave available from the company GKD Gebr. Kufferadt A G, Metallweberstraβe 46, 52353 Düren, Germany under the article number 16370260. This weave has a mesh width of 0.795 mm×1,064 mm and a mesh opening of 1027 microns. For this the wire diameter of both the weft and warp wires is 0.900 mm. GKD normally supply this weave using a stainless steel wire, however for an electrolyser a nickel wire is preferred.

For the finer mesh, for example for the first layer, a square mesh in accordance with DIN ISO 9044 can be used with a 2/2 binding. This mesh is available from GKD using a stainless steel wire under the designation 10371575. Instead of the stainless steel wire used for the weave supplied under this article number by GKD it is necessary to use a nickel wire for the warp and weft wires in the present invention. The warp and weft wires are of 0.26 mm diameter in a 60 mesh weave with mesh openings of 0.163 mm. Another alternative for the finer mesh is a square mesh weave of the same kind (also available from GKD in a 60 mesh) but with a mesh width of 0.173 mm with the warp and weft threads each having a wire diameter of 0.25 mm. GKD sell tis fabric in a pure nickel wire as Article 10231568.

GKD's website lists a variety of weaves that can potentially be adopted for use in the present invention and lists pore sizes for individual weaves. However, the applications quoted for the individual weaves are primarily for use as filters and the pore sizes listed correspond to the size of particles that are filtered out by the individual weaves. The pore size that is of interest for the present invention is, however, the pore size of the individual weaves for flow laterally through the mesh. The idea here is not to filter the flow but to achieve adequate lateral flow permeability. In a weave there will invariably be two sequential weft threads that cross one another from opposite sides of a warp thread forming a weft passage in the warp direction having an approximately V-shaped cross-section. The maximum size of a sphere which will pass along such a weft passage is regarded herein as the pore size of the weave for lateral flow through the weave. It is generally the same as or slightly smaller than the cross sectional size of the warp threads that are used.

Such a pore size concept is in line with the definition given on GKD's website relating to work done by Stuttgart University.

This does not mean that the weft threads all have to alternate in the sense of coming from opposite sides of a warp thread, i.e. from above and below a warp thread, nor that alternating weft threads have to alternate around each warp thread. For example, for each weft repeat, two or more weft threads could pass in parallel through each weft space between sets of warp threads and two or more warp threads could extend in parallel through the weave for each warp repeat.

The weave chosen can be fabricated from a wire of circular cross-section or from a wire of flattened cross-section or from a wire ribbon having a generally rectangular cross-section. Such wires can be used for either the weft or warp threads or for both.

Also wires of any of the above kind can also be used to advantage in a knitted fabric used as the mesh. As an alternative an expanded metal grid can be used as at least one of the electrically conductive meshes and can also be calendared to provide flat knuckles.

As indicated above good electrical contacts between the plate and the layers of electrically conductive mesh and the porous layer(s) of electrically conductive medium can be achieved by the sintering process.

It is also possible to coat the mesh or meshes that are used and if required also the conductive plates with conductive particles in a binder which is evaporated leading to sintered connections between the various components and the particles during the subsequent sintering process in a reducing atmosphere. The coating must be carried out in such a way, e.g. by spraying or spin coating, that the mesh passages are not unduly obscured. Thus, in an electrode having at least one layer of mesh the at least one layer of mesh can advantageously be coated with sintered particles. This can help the sintering of the at least one layer to an adjacent layer and/or to the conductive plate.

Thus, in an electrode of the above described kind the first and second and, if present, the third and fourth layers of woven or knitted wire mesh can, if desired, be coated at least in part with sintered material.

Moreover, by controlling the particle size ranges of the particles used at different components of an electrode it is possible to control the porosity and the electrical conductivity of the individual layers. Particularly preferred for the sintered material sintered onto the wire meshes and in particular for the porous layer(s) are particle sizes in the range from 0.1 microns to 10 microns. When such particle sizes are used for the porous layer(s) the interstitial spaces or pores resulting after the reduction and removal of the binder and sintering have sizes of approximately one tenth of the sizes of the sintered particles that are used. The pores are open pores. That is to say they communicate with one another thus permitting flow through the porous layer.

In an electrode of the above named kind for use in the electrolysis of water to generate hydrogen, the plate, said first and second layers of electrically conductive mesh, if present the third and fourth electrically conductive layers of mesh and said layer or layers of conductive material, i.e. the particles contained in the binder medium, preferably all comprise nickel. This is an ideal metal for the electrolysis of water to generate hydrogen,

In a particularly preferred design the porous layer comprises metal particles having sizes in the range from<0.1 microns to 10 microns, preferably from<1 micron to<5 microns and especially in the range from 1 to 2 microns

In contrast the mesh passages of said at least one layer of mesh have pore sizes for lateral flow through the mesh in the range from 20 microns to 2 mm, preferably in the range from 50 microns to 1 mm and especially of the order of 100 to 200 microns.

If first and second layers of wire mesh are used the first layer of mesh adjacent the conductive plate preferably has mesh passages having a pore size for lateral flow larger than those of the mesh adjacent the porous layer. The pores of the mesh adjacent the porous layer typically are selected to have pore sizes for lateral flow through the mesh in the range from 10 microns to 250 microns, preferably in the range from 50 microns to 150 microns and especially of the order of 100 microns.

The electrode descried above is particularly useful for the anode of each electrolysis cell, However, the structure defined above can readily also be used at a second side the other side of a bipolar plate for the cathode of an adjacent electrolysis cell. It is not essential that the electrode structure used for the cathode is identical to that used for the anode, particularly since there is no large flow of liquid at the cathode side but rather simply moist hydrogen gas.

All electrical contacts between components of the electrodes are preferably sintered, i.e. fused contacts. This insures the electrical resistance of the electrode assemblies is minimized.

As stated above the electrode of the present invention can also be used in fuel cells. It will be appreciated that fuel cells come in various forms. There are for example gas/gas fuel cells, liquid/gas fuel cells and liquid/liquid fuel cells as well as solid oxide fuel cells. Typical gas/gas fuel cells operate with hydrogen or a synthetic hydrogen rich gas as one gas and oxygen or atmospheric air as the other gas. Fuel cells of this kind can be realised using electrodes in accordance with the present teaching.

Basically, the fine porous layer 32 of the cathode space 54 is coated with a catalyst, typically a noble metal such as platinum, and the fine porous layer 32 of the anode space 52 is also coated with a catalyst, again typically platinum. The electrodes in a fuel cell are not based on nickel as in an electrolyser cell but can be another suitable metal such as stainless steel. Instead of an anionic exchange membrane a proton exchange membrane is used.

In operation hydrogen or a hydrogen rich synthetic gas is supplied to the anode space and is split at the catalyst into positive hydrogen ions and negatively charged electrons. The negatively charged electrons flow through the porous layer and the adjacent layer(s) of wire mesh 20, 36 to the anode plate 26 and via an external circuit, for example an electric motor (not shown), to the corresponding cathode plate 26 or bipolar plate 44. They react with the oxygen molecules and the positively charged hydrogen ions that have diffused through the proton exchange membrane to form water molecules that are discharged from the cathode space 54. Thus, in comparison to an electrolyser, liquid, i.e. water, is discharged from the cathode space 54 rather than from the anode space 52 and the hydrogen gas is supplied to the anode space 52 rather than being discharged from the cathode space. Thus, the holders 56 of FIGS. 3 and 4 are arranged the other way round, or, put another way, the cathode and anode spaces 54, 52 are reversed. The use of one or more wire mesh layer(s) in the cathode and anode spaces 54, 52 of a fuel cell based on the electrode design of the present invention, with fused electrical connections between the porous layers 32, the mesh layer(s) 20, 36 and the non-porous electrode plates 26, 44, is particularly beneficial. It leads to excellent flow of the gases through the respective cathode and anode spaces 54 and 52 and to homogenous power generation per unit area of the fuel cells, as well as to a low and highly uniform electrical resistance in the fuel cell.

In the same way as for an electrolyser, a plurality of fuel cells are usually combined into a fuel cell stack. Also, a design with a central electrode as in FIG. 4 is advantageous in a fuel cell stack.

An example of a liquid/gas fuel cell is a so-called direct methanol fuel cell. In a fuel cell of this kind methanol and water, diluted methanol, is fed to the anode space 52 of the fuel cell and the carbon dioxide that is generated there is discharged from the anode space 52. Again, hydrogen atoms are split into protons and electrons. As before, in the hydrogen/oxygen fuel cell, the protons, the positively charged hydrogen ions, diffuse through the proton exchange membrane to the cathode space 54 and the electrons pass through the conductive material of the anode space 52 to the electrode plate (anode) 26, 44 and via an external circuit to the cathode. Oxygen or air is fed to the cathode space and the returning electrons react there with the protons and oxygen to form water which is discharged from the cathode space. Although the direct methanol fuel cell, or a direct ethanol fuel cell which operates in the same way, lead to the generation of some carbon dioxide, this is not so problematic. Indeed, the carbon dioxide can be bubbled through water in the presence of a special copper catalyst to form ethanol. Research on such copper catalysts based on Cuz is well advanced.

Basically, the direct methanol fuel cell based on the present invention is very similar to the hydrogen/oxygen fuel cell described above and the same catalysts are used. It is only necessary to modify the holders that are used to permit the discharge of carbon dioxide from the anode space and water from the cathode space.

In fact, there is a huge class of liquid fuel cells based on the most diverse organic liquids which can also be used with electrodes designed in accordance with the present invention. A discussion of such liquid fuel cells can be found in the article “Liquid Fuel Cells” by Gregori L. Soloviechik of General Electric Global Research, Niskayuna, NY 12309 USA in the Journal of Nanotechnology 2014, 5, 1399 to 1418 published on Aug. 24, 2014.

As mentioned above some fuel cells use hydrogen rich synthetic gas as a fuel and that gas is frequently formed by a so-called reformer from a fuel such as diesel.

The structure of a reformer is very similar to that of a fuel cell and the electrodes of the present invention can also be used in reformers.

Turning now to FIGS. 5A and 5B these show, the anode side and the cathode side respectively of a holder 56 for use in an electrochemical stack comprising a plurality of planar electrochemical cells similar to those used in FIG. 3 or 4. In contrast to the electrochemical stacks of FIGS. 3 and 4 the holder 56 shown here is for use in an electrochemical stack having three stack modules A, B and C.

The holder 56 has an outer periphery having an outline and in use a plurality of such holders 56 is disposed surface to surface in a stacked arrangement adjacent one another. Within each holder 56 there are three openings 58 in this embodiment, here generally square in shape. In use electrodes made in accordance with any of the previously described designs, or otherwise, are mounted so that the anodes are on the sides of the holder adjacent the square seats 78 and the cathodes are on the opposite sides of the holder 56 from the anodes and rest on respective charge transmitting membranes such as 46 which are not shown in these Figures but are trapped against the square seats 78 by the anodes, precisely as described with reference to the drawings of FIGS. 1 to 4.

As described previously the holders 56 with the bipolar plates 44 between them are clamped together between end plates such as 50 which either form end electrodes or press against end electrodes 26 of each stack module of the stack. Each stack module has its own bipolar plates such as 44 disposed between each cell and the neighbouring cell. There are at least two ways this can be done and these are schematically shown in the exploded illustrations of FIGS. 5C and 5D. These FIGS. 5C and 5D are not to scale and unnecessary details have been omitted to facilitate an easy understanding of the drawings.

In the variant of FIG. 5C the holder 56 is of circular disc shape and has respective openings 58 each defining an anode space 52 and a cathode space 54. In FIGS. 5A and 5B there are three such openings 58 and each has a step 78 forming a seat for an anionic membrane 46. However, only two of the openings 58 can be seen in the section of FIG. 5C as a result of the section plane V-V. Actually FIG. 5C is also representative of a similar section plane V-V of FIGS. 6A and 6B in which there are actually four opening 58. FIG. 5C can also be regarded as applicable to other embodiments in which an appropriate section plane is drawn through two o the multiple openings shown.

In the drawing of FIG. 5C there can be seen an end electrode 26 (which could also be an end plate 50) carrying an anode electrode illustrated here with the reference numerals 20, 32 analogously to the electrode 26 of FIG. 1E. The details of the electrode are not shown in order to simplify the drawing. Although not shown in FIG. 5C the electrode 26 could also be an alternative design, for example, without limitation, that of FIG. 2G. There are separate electrodes 26, or 50, for each opening, and the electrodes are spaced apart as shown in FIG. 5C so that there is no electrical connection between them. Ring seals 96 provided on the underside of holder 56 in FIG. 5C around each opening 58 to provide a seal between each end electrode 26 (or end plate 50) and the holder which prevents leakage from the anode space 52.

Above the holder 56 there are provided two bipolar plates 44 over each opening 58, each bipolar plate carrying a lower cathode electrode 20, 32 at its lower side and an anode electrode 20, 32 at its upper side. For example as shown in FIG. 2L. It will be noted that the cathode electrodes in this embodiment are smaller than the anode electrode to take account of the different sizes of the openings 58 on each side of the step 78. The cathode electrodes could, if desired, be made larger than the anode electrodes with the step 78 then facing upwardly in FIG. 5C rather than downwardly. In this case the anionic exchange membrane 46 would be placed on the step from above. The circular bipolar plates 44 in FIG. 5C are spaced apart so that there is no electrical connection between them. Ring seals 98 are again provided in the upper side of the holder 56 around each opening 58 to seal against each bipolar plate and thus to seal the cathode spaces 54. In the finished assembly the end electrodes or end plates and the bipolar plates lie against surfaces of the respective holders disposed between them and not in the positions shown in the exploded assemblies of FIG. 5C and FIG. 5D. Naturally, there is not just one holder in the complete stack module of FIG. 5C but rather a stacked arrangement o like holders 56 with end plates at the ends of each stack module and bipolar plates with associated electrodes disposed between each holder 56 and the next adjacent holder 56. Thus, in this embodiment the ring seals provided between each pair of confronting holders seal do not seal against each other but rather against opposite sides of confronting bipolar plates 44.

The embodiment of FIG. 5D is basically similar to that of FIG. 5C but here recesses are provided on each side of each step 78. The lower recess beneath the step has a depth selected to accommodate the electrode 26 (or end plate 50) with the respective anode 20, 32 and the membrane 46 which is of negligible thickness. Similarly, the upper recesses have depth from the upper surface of each holder 56 to the bottom of each step 78 which corresponds to the thickness of the cathode and the bipolar plate, with the bipolar plates filling the recess above the steps 78. I.e,—the depth of the projections with the seats 78 at their lower sides corresponds to the thickness of the anode electrode

Ring seals 96, 98 are provided in this embodiment in the holders 56 around the openings and seal, in the pressed together state of the stack, against the end electrodes 26 or end plates 50 and between directly confronting (contacting) holders 56, but do not seal against the bipolar plates 44. The outer peripheries of the recesses on either side of the seat 78 can be made circular to facilitate the use of circular electrodes 36 and circular bipolar plates which facilitates good sealing.

This applies irrespective of the outline shape of the opening 68 and the corresponding shape of the ion exchange membrane 46. The variants described with reference to FIG. 5C are also applicable to the embodiment of FIG. 5D.

Finally, it should be noted that ring seals 72′, 80′ can also be provided between each pair of directly confronting holders 56, as indicated in FIGS. 5A and 5B at their outer peripheries, but this is not essential.

As described above in connection with FIGS. 1 to 4 the electrodes of each stack module have outlines corresponding to the outlines of the openings 58 in the holders 56, with the anodes being slightly larger than the cathodes so that they can sit in the anode spaces 52 against the seats 78 in the holders 56 (although the arrangement could be the other way around, i.e. the seats could be provided at the cathode sides of the holders and the cathodes in the cathode spaces 54 could be larger than the anodes and sit against the seats). As before the anodes and the cathode, which are not shown in FIGS. 5A and B are mounted in the openings 58 in the holders 56, as described above in connection with FIGS. 5C and D.

In the design of the holders 56 shown in FIGS. 5A and B each holder 56 has an outer groove 72 for an O-ring seal 72′at one side and another ring groove 80 for another ring seal 80′ precisely as in the arrangement of FIG. 3 However, as illustrated in FIG. 5D, in distinction to FIG. 3 each holder 56 seals directly against the adjacent holder 56 rather than sealing against a bipolar late of the same size as the associated holder 56. In the embodiment of FIGS. 5A the holder 56 has a ring groove 96 at the anode side for a ring seal 96′ disposed around the opening 58 for sealing against an end plate, or an end electrode, or a central connection plate or a bipolar plate 44 of the associated stack module. In FIG. 5B the holder 56 has a ring groove 98 at the cathode side for a ring seal 98′ disposed around the opening 58 for sealing against an end plate, or an end electrode, or a central connection plate or a bipolar plate 44 of the associated stack module. These ring seals are in addition to the ring seals 72′ and 80′ provided t the outer periphery of the holders 56. In a variant of the invention the ring grooves 72, 80 and the associated ring seals 72′, 80′ can be omitted since the sealing function associated with the ring seals 96′ and 98′ for each stack module are sufficient to seal the individual stack modules.

In another variant the bipolar plates could be designed so that, instead of being smaller plates associated with each o the stack modules and sealing against ring seals 96′ and 98′, they are made to have substantially the same extent as the holders 56. However, such an arrangement is not as flexible as one in which each stack module has its own bipolar plates 44, since throughgoing bipolar plates with substantially the same extent as the holders 56 and which are common to all stack modules means that the stack modules are necessarily electrically connected in parallel.

In distinction to the layouts shown in other figures the holders 56 of FIG. 5A and 5B are a completely symmetrical design. That is to say the bores 64 for the supply of electrolyte are provided at the middle of the underside of each opening 58 and merge into the opening at the underside via a divergent manifold 100 which extends halfway through the holder to the level of the recessed seat 78. The bores 70 for the electrolyte leaving the anode spaces are provided at the middle of the upper side of the openings 58 and are fed from a convergent manifold 102. Convergent manifold 102 again extends halfway through the holder 56 from the recessed seat 78 at the node side.

It should be noted that the details of the bores and manifolds described in the immediately preceding paragraph have been omitted from FIGS. 5C and D for the sake of clairity.

In practise it is conceivable that either the outer ring seals 72′ at the periphery of the holders 56 or the circular ring seals 96′ surrounding the individual openings 78 at the anode side could be omitted. Equally it is conceivable that either the outer ring seals 80′ at the peripheries of the holders 56 or the circular ring seals 98′ surrounding the individual openings 78 at the cathode side could be omitted

By using the holders 56 with associated electrodes 26, bipolar plates 44, end plates 50 and/or end electrodes, an electrochemical stack 86 is formed having a plurality of stack modules within the stack, in this case three such stack modules A, B and C.

The circles with crosses 104 in FIGS. 5A and B represent the bores through which clamping bolts used to clamp the stack together pass.

Also, it should be noted that the electrolyte again flows from a common pump such as 106 in parallel through all the anode spaces of the cells of all the stack modules A, B and C, irrespective of how the stack modules are electrically connected together, i.e. in parallel or series.

It can be seen that the reference numerals entered into FIGS. 5A, B, C and D and used in the above description of those Figures correspond to those used in connection with FIGS. 1 to 4. The use of the same reference numerals in connection with FIGS. 5A, B, C and D means that the so identified elements have the same or similar function and the description used for components in FIGS. 1 to 4 will also be understood to apply for the components of the embodiment of FIGS. 5A and B and in all subsequent Figures unless something is stated to the contrary.

FIGS. 6A and B, 7A and B, 8A and B, 9A and B are all similar to FIGS. 5A and B except that they respectively show the use of holders with four, five, six and seven openings 78 respectively, although the openings are of different sizes so as to maximise the size of the openings 78 of the respective holders 56 in order to maximise the ratio of active cell area to holder area referred to above. That is to say the holders 56 of FIGS. 6A and B, 7A and B, 8A and B and 9A and B are respectively designed for four stack modules A, B, C and D, for five stack modules A, B, C, D and E, for six stack modules A, B, C, D, E and F and for seven stack modules A, B, C, D, E, F and G.

Assuming the stack modules of each stack are to be initially electrically separated and only connected together in series or in parallel at a later stage then they each have to be provided with their own end plates, end electrodes, bipolar plates and central connection electrode with insulation around these components. This is necessary so that they are electrically separated from the corresponding components of the other stack modules of the stack. The insulation for this can be provided by special holders (not shown) distinct from the holders 56 and extending, apart from the requisite openings for the named components of the stack modules over the full cross section of the stack. Alternatively, the insulation for the components could be provided by extending the axial thickness of the adjacent holders 56, which also extend over the full cross-section of the stack, and providing recesses in the extensions to accommodate the said components. In addition, it is necessary to provide for electrical terminal connections to the end plates or end electrodes and to the central connection plates so that these can be accessed from the outside of the stack. It is also necessary to provide seals (also not shown) in the extra holders or the extended holders to prevent leakage from the stack and from the stack modules.

FIGS. 10A and B show a design of a holder 56 with a circular outline but one which has just two openings 58 to accommodate the electrodes of two stack modules A and B. In this design the openings 58 are rectangular rather than square in order to maximise the ratio of active cell area to holder area. This embodiment also shows that the electrodes can be rectangular rather than square and this is no way disadvantageous. Rectangular electrodes can also be cut from sheets of mesh without material wastage.

FIGS. 11A and B show that the rectangular openings for rectangular electrodes used in FIGS. 10A and B can also be arranged in holders having an elliptical outline. The optional ring seal grooves 96 and 98 around each opening enable the use of flexible circular O-rings because the change in curvature around these grooves is gradual and can be accommodated by the O-rings without loss of sealing. As usual the grooves for the O-rings have a rectangular cross-section. The use of an elliptical outline for the holders can permit a slight reduction in the amount of material required for the holders and this contributes to maximising the ratio of effective electrode area to holder area.

FIGS. 12A and B show that the holders 56 can also have an outline formed by straight lines and curves. In this case the outline of the holder is formed by two parallel straight lines of equal length with two semi-circular regions adjoining the ends of the straight lines. A shape such as this can also be of benefit with two rectangular openings 78 as shown. Alternatively, a plurality of square or rectangular openings (or other shaped openings) can be arranged in one or more straight lines (not shown). Again, the advantage is achieved that O-ring seals can be provided around the outer periphery of the holder and/or around the openings 78 without loss of sealing. Other outlines could also be considered, for example three straight lines arranged in a triangle with spaced apart ends joined by circularly curved regions.

FIGS. 13A and B show that holders 56 with a polygonal outline can also be used, here in the form of a hexagon. In this case the openings 58 for the stack modules A and B are of rectangular shape but other shapes could also be considered.

FIGS. 14A to L show a variety of alternative shapes for the outlines of the openings 58 in the holders 56 with FIGS. 14A to F showing the anode sides and FIGS. 14G to L showing the cathode sides. The variants of FIGS. 14A to C and G to I are all favoured because the respective meshes can all be cut from sheets of mesh without material wastage.

FIG. 15 shows a stack with four modules A, B, C and D with the modules being arranged in pairs A and B and C and D alongside one another. The holders 56 for each of the pairs can, for example, have the shapes shown in FIGS. 10A and B, 11A and B or 12A and B. It can be seen from this drawing that the holders 56 and the bipolar plates 44 and thus the electrodes 26 and the anode and cathode spaces 52 54 within the holders 56 are arranged vertically. This is the preferred arrangement because the flow of electrolyte laterally through the mesh(es) in the plane of the meshes or weave takes place vertically upwardly in the anode spaces 52 and thus gravity, i.e. the resulting buoyancy, drives the oxygen upwardly through each cell to the outlet passages 84. This is also the reason that all stack modules A to G of a stack preferably have the same orientation, otherwise the gravity assisted separation of oxygen from the anode spaces 52 would not arise to the same high degree in all stack modules.

Turning now to FIG. 15 it can be seen that each of the four stack modules A, B, C and D basically has the same arrangement as in FIG. 4, i.e. the central connection plate 94 of each stack module A, B, C and D is connected to one terminal of a DC or quasi DC power supply (rectified AC power supply or rectified three phase power supply) whereas the two end plates 50 and/or the end electrodes 26 of each stack module A to D are connected to the other terminal of the DC power supply. In this embodiment the two stack modules A and B are arranged directly above one another in one tier of the arrangement and the two further modules C and D are also arranged directly above one another in a second tier of the arrangement. All of the stack modules are horizontally arranged for the reasons given above. The word “tier” is thus used here loosely and does not imply a vertical arrangement of tiers.

In this embodiment the end plates 50, the end electrodes 26 and the bipolar plates 44 as well as the central connection plates 94 extend over the full area of the holders 56 of the respective pairs of modules A, B and C, D and this means that the two pairs of stack modules A, B and C, D are inevitably connected electrically in parallel as shown. Insulating regions 136 of the insulating holders 56 are provided between the pairs of stack modules A, B and C, D. There is also insulation 138 between the two tiers formed by the pairs of modules A, B and C, D. The circuit connections made in FIG. 15 also means that both pairs of modules A, B and C, D are electrically connected in parallel. The equivalent circuit for this is shown in FIG. 17A. However, it is also possible to connect the pairs of modules A, B and C, D arranged above one another in parallel and to connect the two pairs A, B and C, D in series.

A circuit which enables these two alterative connections is shown schematically in FIG. 17B. Although the stacks A, B and C, D of FIG. 15 are arranged in pairs in two tiers, it will be appreciated by those skilled in the art that the equivalent circuits of FIGS. 17A and B can also be applied to four stack modules arranged in one tier, e.g. using the holder layout of FIGS. 6A and B.

In addition it will be appreciated that any of the holder layouts of FIGS. 5A and B, 6A and B, 7A and B, 8A and B and, 9A and B could also be arranged in two tiers analogous to FIG. 15 or 16 resulting in stacks with six, eight, ten, twelve or fourteen stack modules. Moreover, the stack modules can be arranged in more than two tiers if desired so that even more stack modules are present in the stack.

The arrangement of FIG. 16 is basically similar to that of FIG. 15 but in this case the end electrodes and the bipolar plates are of a shape and size corresponding to the cross-section of the respectively associated stack modules A, B, C and D, i.e. are not shared by a plurality of the stack modules. This provides the freedom for the stack modules to be connected in series or in parallel to a DC power supply or quasi-DC power supply as desired.

FIG. 17C schematically shows, by way of example, how the four stack modules of FIG. 16 can be connected in series. It will be apparent to a person skilled in the art that the connection scheme of FIG. 17C can also be applied to four stack modules A, B, C and D arranged in one tier, as indicated in FIG. 6A and B, to connect all four modules in series.

Also, it will be readily apparent that the concept outlined in FIG. 17C for connecting four stack modules electrically in series can be extended further to any number of stack modules. Moreover, it will be readily apparent to a person skilled in the art that relay based switching circuits or semiconductor-based switches cam readily be provided to permit any of the stack modules to be connected in parallel, or in series, or with different groups of the stack modules in parallel and the groups in series, to an associated power supply. An algorithm is preferably provided to flexibly connect the stack modules such that, over a longer period of time, each stack module is in operation for about the same length of time.

The algorithm is stored in a computer which receives, as an input, a signal of the amount of power available from a solar panel assembly, or from a wind generator or from a tidal power generator or from a hydroelectric generator, and which controls the switches accordingly. Again, the flow of the electrolyte is such that this flows from a common pump through all the stack modules in parallel irrespective of whether the stack modules are connected electrically in series or in parallel. It is also possible for the electrolyte to flow through a stack which is switched off without significant disadvantages, but with a significant saving in complexity. As discussed before, the outlets 70 from the anode spaces 52 are connected together via the bores in the holders 56 and are connected to a common collector 108, where the oxygen is separated from the electrolyte which is recirculated by the pump 106.

Although the preferred embodiment of the present invention as described above has holders 56 with an overall diameter of circa 300 mm and stack modules each having a square active electrode area of circa 80 mm×80 mm (the size of the openings for the cathode spaces), this should in no way be taken as a restriction on the size of the holders, or on the active electrode area or on the shape of the active electrode area. The concept of the invention as claimed in claim 1, using a plurality of smaller stack modules in a single stack, rather than a single stack with a larger active area of the cells, can yield significant benefits for other sizes of stack and stack modules. Thus, there is basically no restriction on the sizes of the stack and stack modules to which the present invention can be applied.

On the other hand, as shown above, the preferred design with seven stack modules per stack and tirty cells on each side of the central connection plate and with active electrode areas of 80 mm×80 mm results in very high power stacks with a very compact design, that enables powers in the megawatt range to be used for electrolysis, With the example described above a relatively small number of stacks, e.g with four stacks in a rack and a total of six racks a 2 MW power input can be highly efficiently converted into hydrogen and oxygen by the electrolysis of water containing, e.g. KOH.

Thus, there is no need to go to huge stacks to achieve economic electrolysis.

### LIST OF REFERENCE NUMERALS

A stack module
B stack module
C stack module
D stack module
E stack module
F stack module
G stack module
10 mould
12 internal base surface of mould
14 layer of slurry
16 particles
18 binder medium
20 (first) layer of electrically conductive mesh, contacts porous layer 32
22 lower knuckles of mesh 20
24 upper knuckles of mesh 20
26 conductive non-porous metal plate
28 side walls of mould 10
30 finished assembly (electrode or catalyst carrier)
32 porous layer
34 first mesh passages
36 (second) layer of electrically conductive mesh, contacts metal plate 26
38 second mesh passages
40 lower knuckles of electrically conductive mesh 36
42 upper knuckles of electrically conductive mesh 36
44 bipolar plate
46 anionic exchange membrane
48 electrode stack of an electrolyser
50 conductive plate, anode or cathode connection to a stack
52 anode space
54 cathode space
56 holder
58 square opening
60 transverse feed groove for an anode space 52
62 short feed passages for an anode space 52
64 main feed passage for the anode spaces 52
66 outlet groove for electrolyte and oxygen leaving an anode space
68 outlet passages for electrolyte and oxygen leaving an anode space
70 main outlet passage for electrolyte and oxygen leaving an anode space
72 O-ring groove
72 O-ring
74 O-ring groove
76 O-ring groove
78 recessed square seat for anionic membrane
78′ axial recess on anode side of seat 78
78″ axial recess on cathode side of seat 78
80 O-ring groove
80′ O-ring
82 transverse grooves communicating with cathode spaces 54
84 axial passages communicating with transverse grooves 82 for removing hydrogen from the cathode spaces
86 electrolyser stack
88 O-ring groove
90 photovoltaic panel
92 sunlight incident on panel 90
94 non porous conductive central connection plate
96 O-ring grooves at anode side
96′ O-rings
98 O-ring grooves at cathode side
98′ O-rings
100 diverging inlet manifold
102 converging outlet manifold
104 holes for clamping bolts
106 pump for electrolyte
108 container for supply of electrolyte
110 tube
112 feed line for electrolyte
114 inlet passage for electrolyte
116 outlet passage for electrolyte and O₂
118 plugs
120 return line for electrolyte and O₂ to container
121 line for extracting oxygen from container 108
124 pump for pumping O₂ into collector 126, or, alternatively, a non-return valve
125 line to oxygen collector 126
126 collector for O₂
127 hydrogen outlet line
128 pump for H₂, 126, or, alternatively, a non-return valve 129 line for H₂
130 collector for H₂
132 metering valve for topping up electrolyte in container 108
134 reservoir for supply of electrolyte to container 108
136 insulating regions of the holders between pairs of modules A, B and C, D
138 insulation between the pairs of modules A, B and C, D

1. An electrochemical stack comprising a plurality of planar electrochemical cells having surfaces bounded by outlines and disposed surface to surface adjacent one another with bipolar plates disposed there-between, the cells being mounted in respective openings having corresponding outlines in insulating holders, the holders being clamped together between end plates or end electrodes and there being seals between each end electrode or plate and the adjacent holder (56) and between confronting regions of adjacent holders, wherein each cell has an anode and a cathode with a charge exchange membrane disposed between them, with the anode and the cathode contacting respective sides of the charge exchange membrane characterised in that a plurality of stack modules are provided in the holders and between the end electrodes or plates, with each holder having a plurality of openings, each for one cell of one of the stack modules and in that the stack modules and in that each charge exchange membrane is, one of an anion exchange membrane and a proton exchange membrane.

2. The electrochemical stack in accordance with claim 1, wherein each stack module has the same orientation in space, and wherein the stack is arranged with the cells in a vertical plane or sloping upwardly so that inlets to each anode space for electrolyte are arranged downwardly in the stack and in that the oxygen and electrolyte outlets of each anode space are arranged upwardly in the and also the end plates are of circular shape, or of elliptical shape or of polygonal shape or have a shape formed by curves and straight lines.

3. The electrochemical stack in accordance with claim 1, wherein seals are provided between a peripheral margin of each end electrode or plate and the peripheral margin of an adjacent holder and between confronting peripheral margins of the holders.

4. The electrochemical stack in accordance with claim 1, wherein seals are provided around the openings in each holder between the end electrodes or plates and the adjacent holders and between the confronting holders and are located in respective grooves formed around openings of square shape, of rectangular shape, of circular shape, or of elliptical shape, or of a shape formed by curves and straight lines, the grooves optionally being of rectangular or square-cross section.

5. The electrochemical stack in accordance with claim 1, characterised in that wherein the seals between confronting regions of adjacent holders seal against respective bipolar plates provided between each two consecutive holders.

6. An electrochemical stack in accordance with claim 5, wherein the end electrodes and/or the bipolar plates are either located in respective recesses in the holders around each of the openings or overlap the holders at the respective openings.

7. The electrochemical stack in accordance with claim 1 in which the planar cells have generally rectangular, square, polygonal, triangular, trapezoidal, sector-shaped, circular or rhomboid surfaces or outlines.

8. The electrochemical stack in accordance with claim 1 in which each stack module is surrounded by a plurality of respectively associated seals, the respectively associated seals being disposed between the end electrodes or plates and the adjacent holders and between the confronting holders and being located in respective grooves of circular shape, or of elliptical shape, or of a shape formed by curves and straight lines surrounding the cells of each of the stack modules.

9. The electrochemical stack in accordance with claim 1, wherein from two to nineteen stack modules are present.

10. The electrochemical stack in accordance with claim 1, wherein the stack modules have anode spaces that are fed with an electrolyte from a common pump and that the outlets of the anode spaces of the stack modules are connected to a common collector with an oxygen separator and a return line for the electrolyte to the common pump.

11. The electrochemical stack in accordance with claim 1, wherein each stack module has its own associated power supply terminals and wherein a circuit is provided for variably connecting power supply terminals of the stack modules in series and/or in parallel whereby, over a longer period of time, each stack module is in operation for about the same length of time.

12. The electrochemical stack in accordance with claim 1, wherein from 11 to 123 bipolar plates are provided respectively corresponding from 12 to 124 cells in each stack module.

13. The electrochemical stack in accordance with claim 1, wherein an even number of cells is present in each stack module there being bipolar plates between the adjacent cells and end electrodes or end plates at the ends of the stack modules, and wherein the central bipolar plate of each stack module is connectable to one pole of a power supply and the end electrodes or end plates at the ends are both connectable to another pole of the power supply.

14. The electrochemical stack in accordance with claim 1, wherein the electrochemical stack has an associated power supply in the form of a DC-power supply, the DC power supply being one of an output voltage of a solar panel assembly, or a rectified or unsmoothed voltage from a alternating current generator or from a three phase generator.

15. (canceled)

16. The electrochemical stack in accordance with claim 1, wherein the stack is arranged with the cells in a vertical plane or sloping upwardly so that inlets to each anode space for electrolyte are arranged downwardly in the stack and the oxygen and electrolyte outlets of each anode space are arranged upwardly in the stack.

17. The electrochemical stack in accordance with claim 1, wherein either all stack modules of a stack have common end electrodes and bipolar plates and optionally a common central connection plate, or
at least one group of stack modules of a stack have common end electrodes and bipolar plates and optionally a common central electrode, with the remaining stack modules of the stack are electrically insulated from each other and each has its own end electrodes and bipolar plates and optionally its own central electrode, or
each stack module of the stack is electrically insulated from each other stack module and each has its own end electrodes or end plates and bipolar plates and optionally its own central electrode.

18. The electrochemical stack in accordance with claim 17, wherein each stack module of the stack that is electrically insulated from any other stack module of the stack and any group of stack modules of the stack has its own electrical connection terminals which can be connected together and to any other electrical connection terminals of stack modules of any other stack to provide any desired parallel or series connections between the stack modules of the stack or stacks.

19. The electrochemical stack in accordance with claim 1, wherein each stack module of the stack has thirty cells on each of two opposite sides of a central connection plate.

20. The electrochemical stack in accordance with claim 9, wherein from four to seven stack modules are present.

21. The electrochemical stack in accordance with claim 19, wherein seven stack modules are provided in the stack.
